(19) United States
(12) Patent Application Publication
(10) Pub. No.: US 2005/0073690 A1
(43) Pub. Date: Apr. 7, 2005

(54) Optical spectroscopy incorporating a vertical cavity surface emitting laser (VCSEL)

(76) Inventors: Russell E. Abbink, Sandia Park, NM (US); John D. Maynard, Albuquerque, NM (US); Trent D. Ridder, Sandia Park, NM (US)

Correspondence Address: INLIGHT SOLUTIONS, INC., 800 BRADBURY, SE, ALBUQUERQUE, NM, 87106, US

(21) Appl. No.: 10/678,843

(22) Filed: Oct. 3, 2003

(51) Int. Cl. G01B 9/02

(52) U.S. Cl. 356/451

(57) ABSTRACT

A vertical cavity surface-emitting laser (VCSEL) package useful in interferometry. The present invention comprises methods and apparatuses that allow use of multimode VCSELS, and that provide for wavelength control and stability. The present invention contemplates the use of a defined response element, such as an etalon, in combination with control of the operating environment of the VCSEL to monitor and control the output wavelength of the VCSEL.

### RELATED APPLICATIONS

This application claims priority under 35 U.S.C. § 120 to U.S. application Ser. No. 10/116,267, “Method And Apparatus For Optical Spectroscopy Incorporating A Vertical Cavity Surface Emitting Laser (VCSEL) As An Interferometer Reference”, filed Apr. 4, 2002, and to U.S. application Ser. No. 10/116,271, “Apparatus And Method For Reducing Spectral Complexity In Optical Sampling,” filed Apr. 4, 2002, the disclosures of which are incorporated herein by reference.

### TECHNICAL FIELD

The present invention generally relates to the field of diagnostic spectroscopy, and more specifically, to a method and apparatus for providing a light source for Fourier transform spectrometers. More specifically, the present invention comprises a subsystem including a vertical cavity surface emitting laser (VCSEL) and selected components.

### BACKGROUND OF THE INVENTION

In interferometry such as that used for optical spectroscopy, reference lasers are used to provide the ability to obtain digitized interferogram points that are equivalently spaced in position, which is a requirement of Fourier transform algorithms. The industry standard reference is the helium neon laser because of its inherent lasing wavenumber stability and its relatively small size and low cost when compared to other gas lasers. Lasers can also be used in some applications as light sources for the interferometer.

International Publication WO 00/49690 to Singh et al. and entitled “Compact Wavelength—Independent Wavelength—Locker for Absolute Wavelength Stability of a Laser Diode” discusses the wavelength stabilization of a laser diode by tapping a fraction of the laser diode's output and passing it through a narrow band power splitter to two detectors. The signal from the two detectors is compared, and predetermined control signals are used to maintain a constant lasing wavelength. The need for wavelength stability for wavelength division multiplexed (WDM) transmission systems is disclosed. Application of laser diodes for spectroscopic purposes is not disclosed. In addition, the patent application disclosed wavelength control through the utilization of optical feedback that is obtained from a dedicated diode laser control system. The control of wavelength stability requires significant additional electronics.

International Publication WO 01/20371 to Watterson et al. and entitled “Wavelength Reference Device” describes an apparatus for use in calibrating a tunable Fabry-Perot filter or tunable VCSEL to a precise absolute frequency and maintenance of that frequency using optical feedback derived from a Michelson interferometer. The drawbacks of this method are that the optical feedback system must be included in any application of a VCSEL, and a method of absolute lasing wavelength determination must be available. The desirable low cost feature of VCSELs relative to existing laser reference technology is negated by the described optical feedback system. The VCSEL lasing wavenumber control is provided by an additional optical feedback system. Further, the apparatus of Watterson et al. relies on absolute frequency to maintain a lasing wavenumber.

U.S. Pat. No. 6,069,905 to Davis et al. and entitled “Vertical Cavity Surface Emitting Laser Having Intensity Control” describes the incorporation of a photo detector into a VCSEL package for the purposes of intensity control. This method focuses solely on optical power and intensity regulation and control, which is not critical for the purposes of the application of VCSELs as references for interferometric spectrometers. Davis et al. do not disclose the control and correction of VCSEL lasing wavenumber shifts.

U.S. Pat. No. 5,267,152 to Yang et al. and entitled “Non-invasive Method and Apparatus For Measuring Blood Glucose Concentration” describes the use of solid state lasers as sources of electro-magnetic radiation for the non-invasive measurement of blood glucose concentration. Yang et al. do not describe the use of a solid state laser as a wavenumber reference for interferometry. The control of the solid state laser current, voltage and temperature are discussed because the measurement of blood glucose concentration, as described in this patent, is dependent on these parameters.

U.S. Pat. No. 5,933,792 to Andersen et al. and entitled “Method of Standardizing a Spectrometer” describes the use of a standardization sample to determine a characteristic shape, which embodies the difference in response of an instrument over time or between instruments, for absorbance and wavenumber calibration. The limitation of this method is that the characteristic shape is used to correct spectra obtained at later times or on different instruments. The spectra themselves are not inherently correct. The disclosed apparatus does not deal with wavenumber calibration through control and correction of the optical component that determines the spectral wavenumber axis. Instead, it requires a characteristic shape that embodies the spectral differences to correct the spectral wavenumber axis.

In addition, U.S. Pat. No. 5,933,792 discloses a method of standardizing a Fourier transform infrared (FTIR) spectrometer that uses a HeNe laser as its reference. It does not discuss the use of a VCSEL as the reference for the FTIR spectrometer. The HeNe laser has relatively high cost, high power, generates more heat and occupies a large volume relative to a VCSEL. The present invention discloses the method and apparatus of a subsystem or subassembly necessary for successful use of a VCSEL as a reference for an interferometer in optical spectroscopy.

### SUMMARY OF THE INVENTION

The present invention is directed to a subsystem for use in interferometry for optical spectroscopy applications which makes possible the use of a vertical cavity surface emitting laser (VCSEL), for example to serve as an accurate and precise reference laser as an alternative to the industry standard HeNe laser. The present invention offers substantial cost, size, heat and power consumption reductions compared to the HeNe laser. In some embodiments, the present invention makes feasible the use of the VCSEL as a reference for an interferometer by incorporating electronics to drive the VCSEL, a photodetector sensitive to the VCSEL output, an algorithmic wavenumber shift estimation and correction algorithm or method which utilizes a known sample. The invention can also provide automatic wavelength stabilization.

An embodiment of the present invention is a subassembly for use in an optical spectroscopy system. The subassembly can include an interferometer having optical components for receiving light and passing light along a defined light path. The optical components can include a beamsplitter that separates the light from a source into two portions and means for introducing a pathlength difference between the two portions. A vertical cavity surface emitting laser, including electronics to drive the vertical cavity surface emitting laser and project a beam therefrom can be operatively mounted on the interferometer with the beam following the defined light path to act as a reference laser for the interferometer. The interference pattern of the laser can be received by a photodetector so that pathlength differences and an accurate digitized interferogram may be constructed for a sample under analysis. The vertical cavity surface emitting laser can include means for temperature control and means for current control connected thereto along with computing means having therein an algorithm for correcting wavenumber drift by the vertical cavity surface emitting laser.

In some embodiments, the algorithm for correcting wavenumber drift by the vertical cavity surface emitting laser includes factors derived from spectroscopic analysis of a reference sample utilizing the interferometer and vertical cavity surface emitting laser of the subassembly. At least a portion of the generated spectrum can be compared to a known spectrum for the reference sample. The comparison can include analysis of the relative difference between the generated spectrum and the known spectrum of the reference at selected wavenumbers. Other types of algorithms can be utilized which rely on such methods as employing a derivative-based determination of wavenumber location of spectral features, a center of gravity based determination of wavenumber location of spectral features, an interpolation-based determination of wavenumber of location of spectral features or a wavenumber shift versus wavenumber regression to determine shift correction.

In an alternative embodiment, the algorithm for correcting wavenumber drift by a vertical cavity surface emitting laser can be derived from multiple spectroscopic analysis of a reference sample having a known spectrum utilizing a second interferometer and a second vertical cavity surface emitting laser of the same type as that utilized in the subassembly. The algorithm derived from the similar system can then be utilized as a predictor for performance of the vertical cavity surface emitting laser in the subassembly.

The vertical cavity surface emitting laser of the present invention also can include means for controlling the operating environment of the VCSEL, for example means for temperature control and means for current control. The means for temperature control can include a temperature measurement device to provide a feedback signal to the control circuit, a set point signal, a Wheatstone bridge to compare the feedback signal to the set point signal, proportional integral and derivative (PID) filter to provide the control properties of the circuit, a reference voltage supply, and a MOSFET to regulate the output of the circuit using the signal obtained from the PID filter. A temperature monitor can also be included in the circuit. The means for current control preferably includes a precision voltage power supply, a precision resistor with low temperature coefficient to convert the output of the precision voltage supply to current, and a current monitor.

The reference sample having a known spectrum can be selected to include at least one rare-earth oxide. The rare-earth oxide may be doped into a diffusely reflective substrate or alternatively doped into a transmissive substrate. Preferred earth oxides include erbium oxide, dysprosium oxide, holmium oxide or samarium oxide. In alternative embodiments, the reference sample having a known spectrum can be a rare gas emission lamp which is selected from a neon emission lamp, a krypton emission lamp, an argon emission lamp or a xenon emission lamp. The reference sample could also include one or more etalons that may be measured simultaneously or in series.

In some embodiments, the subassembly is mounted in a spectrometer system that includes a sample holder. A reference sample can be measured while positioned in the sample holder.

Some embodiments of the present invention provide for automatic wavelength stabilization. A defined response element, for example an etalon, can be mounted in an optical path from the VCSEL to a detector. A detector associated with the interferometer can be used, or a separate detector can be used. The operating environment, e.g., drive current or operating temperature, of the VCSEL can be controlled so that the associated detector indicates a defined characteristic, e.g., a maximum or minimum. The output wavelength of the VCSEL can thereby be controlled so that it remains at the wavelength where the defined response element yields the defined characteristic at the detector. Such stabilization can be performed in a continuous manner, or can be performed periodically, for example before or after measurement events of an associated spectroscopy system.

### BRIEF DESCRIPTION OF THE DRAWINGS

FIG. 1 is a schematic representation of a portion of an optical spectrometer including an interferometer having both a light source and VCSEL reference laser following defined light paths therethrough;

FIG. 2 shows a typical interferogram created by an FTIR spectrometer;

FIGS. 3A-3C graphically depict the effect of wavenumber axis instability on Beer's law predictions;

FIG. 4 is a diagram illustrating wavenumber shift due to alignment error;

FIG. 5A is a block diagram of a generalized current supply;

FIG. 5B is a diagram of an exemplary VCSEL drive current circuit;

FIG. 6 is a graph depicting VCSEL drive current and ambient temperature over time for the system of FIG. 5B;

FIG. 7A is a block diagram of a generalized temperature control circuit;

FIG. 7B is a diagram of an exemplary VCSEL heater control circuit;

FIG. 8 is a graph depicting heated VCSEL and ambient temperature over time for the system of FIG. 7B;

FIG. 9 is a diagram of an exemplary VCSEL TE cooler control circuit;

FIG. 10 is a graph depicting cooled VCSEL and ambient temperature over time for the system of FIG. 9B;

FIG. 11 depicts a spectrum of erbium, dysprosium, and holmium oxides doped into a spectralon reference sample;

FIG. 12 depicts a samarium and holmium oxide doped into a glass substrate reference sample;

FIG. 13 depicts a spectrum of a xenon emission lamp reference sample;

FIG. 14 illustrates spectra of rare-earth doped spectralon obtained over a range of temperatures;

FIG. 15 graphically depicts temperature vs. wavenumber shift for the 6456 cm−1 peak;

FIG. 16 graphically depicts an example of beta regression; and

FIG. 17 graphically depicts experimental results from a PCA analysis demonstrating the effectiveness of correction methodology.

FIG. 18 graphically depicts experimental results from a PCA analysis demonstrating the effectiveness of correction methodology.

FIG. 19 is a schematic representation of a wavelength-stabilized VCSEL subsystem according to the present invention.

FIG. 20 is a schematic representation of a wavelength-stabilized VCSEL subsystem according to the present invention.

FIG. 21 is a schematic representation of a wavelength-stabilized VCSEL subsystem according to the present invention.

FIG. 22 is a schematic representation of a wavelength-stabilized VCSEL subsystem according to the present invention.

FIG. 23 is an illustration of wavelengths useful in understanding the operation of the present invention.

FIG. 24 is a schematic representation of a wavelength-stabilized VCSEL subsystem according to the present invention.

### DETAILED DESCRIPTION OF THE PREFERRED EMBODIMENTS

Until the late 1960's, FTIR spectrometry was largely unaccepted as a useful analytical method due in part to poor scan to scan reproducibility. The advent of rare-gas lasers, specifically the helium-neon laser, allowed the direct monitoring of the moving mirror position in an interferometer. Using a helium-neon (HeNe) laser, which can be obtained with wavelength stability to nine digits of precision, the position of the moving mirror could be elucidated by finding the zero crossings of the laser's interferogram. Consequently, interferograms can be digitized at precisely equal intervals of mirror position, where each interval corresponds to a distance of exactly half of a wavelength of the laser line. The result of the application of a HeNe reference was an internal wavenumber axis standard for measurements on FTIR spectrometers. In addition, some interferometric applications use integral numbers of laser zero crossings to define the total distance traveled by the moving mirror and thus define spectral resolution.

HeNe Lasers

Helium-neon lasers have several disadvantages for several applications, however. The primary disadvantages are size, cost, lifetime, and power consumption. The minimum size of a helium-neon laser cavity is fundamentally limited to approximately 6 inches in length. This limitation is imposed by the spacing between the two internal mirrors that form the Fabry-Perot resonator in the lasing cavity. The equation that determines the allowed lasing wavelengths for a given mirror spacing is given in Equation 1.

$$λ = \frac{2 L}{n} \qquad ( 1 )$$

where L is the distance between the two mirrors, λ is the lasing wavelength for a given value of n, and n is a constant that is defined by the reflectivity function of the mirrors at the wavelength of interest. For the neon emission lines around 632.8 nm, the possible values of n limit the mirror spacing to around 6 inches.

While the cost of HeNe lasers is significantly lower than nearly every other type of laser, a spectroscopic grade HeNe and associated power supply is still presently around $500. This expense is a minor concern for laboratory Fourier transform infrared (FTIR) spectrometers, which can cost in excess of $50K. For instruments intended for the consumer market, however, the cost of the HeNe is significant and therefore affects the commercial feasibility of any product incorporating a spectroscopic system that requires a laser reference.

The lifetime of the HeNe laser is also a disadvantage. The typical lifetime of a HeNe laser is around 15,000 hours. Assuming constant use, a HeNe laser can need replacement approximately every two years. In laboratory spectrometers, the time and expense of HeNe replacement is usually a fairly minor concern when compared to the spectrometers initial and continuous operating costs. Consequently, the lifetime of HeNe lasers in laboratory spectroscopy has generally not been considered a disadvantage, but can be a disadvantage in a consumer product if replacement is required every two years.

The power supply requirements of a HeNe laser make its use in consumer devices difficult. In order to initiate lasing in a HeNe laser, a starting voltage of 5 to 12 kV must be applied. Once lasing has been initiated, a constant 1 to 3 kV at 3 to 8 mA must be supplied to maintain the laser's output. This corresponds to a possible 24 W of continuous power consumption. In addition, the stability of the supplied power is directly related to the stability of the laser emission. Consequently, a highly stable power supply is desirable. The design, operation, and size of a power supply that meets these requirements make it unattractive for a consumer product, especially if the device must be portable or battery powered.

Subassembly Using a VCSEL

The present invention is based on a subsystem that makes vertical cavity surface emitting lasers (VCSELs) a viable alternative to the HeNe laser as a reference in FTIR spectrometers. A representative interferometer that can incorporate the subsystem of the present invention is disclosed in commonly assigned U.S. patent application Ser. No. 09/415,600, filed on Oct. 8, 1999, and entitled “Interferometer Spectrometer with Reduced Alignment Sensitivity,” the disclosure of which is incorporated herein by reference.

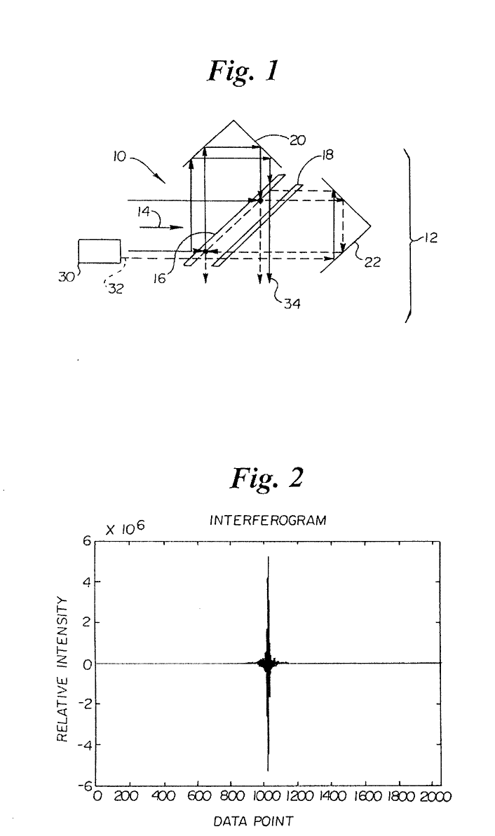

A schematic representation of a representative subassembly 10 of the present invention is depicted in FIG. 1. The subassembly generally includes an interferometer 12 that modulates sufficiently collimated light 14 directed to the subassembly 10 to create an interferogram that is received by a detector (not shown). The interferogram spatially encodes the spectrum collected from a sample or a source. In the embodiment depicted in FIG. 1, the interferometer 12 includes a beamsplitter 16 and the compensator optics 18, a fixed retro-reflector 20 and a moving retro-reflector 22. The collimated input light 14 impinges on the beamsplitter optic 16 and is partially reflected and partially transmitted by the coating on the back surface of the beamsplitter 16. The reflected light passes back through the beamsplitter optic 16 and reflects off the fixed retro-reflector 20 and back to the beamsplitter 16. The transmitted and reflected portions of the light recombine at the beamsplitter to create an interference pattern or interferogram. The amount of constructive and/or destructive interference between the transmitted and reflected beams is dependent on the spectral content of the collimated input beam 14 and on the optical path difference between the fixed retro-reflector 20 and the moving retro-reflector 22.

FIG. 2 shows a typical interferogram created by an FTIR spectrometer. At the point of zero path difference between the transmitted and reflected beams, there will be maximum constructive interference, and the centerburst of the interferogram is created. The interferogram is then focused onto a detector 232, as shown in FIG. 1. The detector 232 converts the optical interferogram into an electrical representation of the interferogram for subsequent digitizing by a data acquisition subsystem.

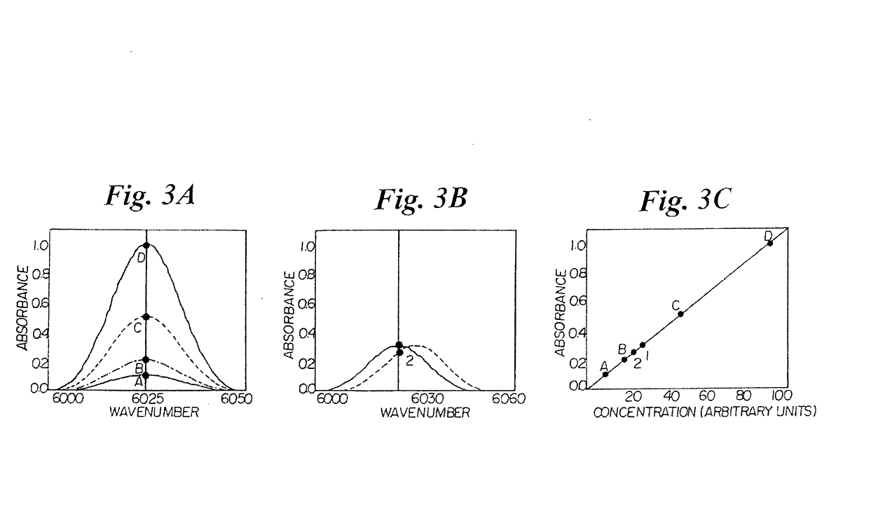

Also depicted in FIG. 3 is a reference laser assembly 30 of the present invention as described in detail below. The reference laser subsystem is a VCSEL package which can incorporate power control, temperature control, and a wavenumber axis correction based on an algorithm developed from known reference sample measurements on either the system of FIG. 1 or another similar system. The reference laser assembly generates an output beam 32 that is projected onto the beamsplitter 16. The portion of the beam is reflected to the fixed retroreflector 20 that in turn passes back to the beamsplitter 16. A portion of the laser beam 32 also is transmitted through the beamsplitter 16 and compensator optics 18 to the moving retro-reflector 22 and also back to the beamsplitter 16 where it is recombined with the portion of the beam reflected from the fixed retro-reflector to create an interference pattern based on the single wavelength of the laser with the resulting beam 34 being directed to a photodetector sensitive to the wavelength of the laser beam. As described in detail below, the reference beam allows determination of the moving retro reflector 22 position at any time and provides spectral resolution and wavenumber axis determination.

Similar to helium neon lasers, VCSELs offer circular beams with low beam divergence that makes them suitable for use as references in interferometry. In addition to their desirable optical properties, VCSELs offer substantial improvements over HeNes in several categories important for a mass-produced commercial device. The size of a typical VCSEL package is approximately 5 mm in each dimension, which results in a volume of approximately 0.125 cm³. In comparison to a typical HeNe, which has a volume of approximately 75 cm³, a VCSEL is 600 times smaller.

As mentioned above, an important requirement of a reference laser in FTIR spectroscopy is wavelength stability of the laser's emission. Standard VCSELs have been shown to fall short of their HeNe counterparts in this area. It has been found that a VCSEL architecture results in its lasing wavenumber being dependent upon temperature, drive current, and long-term sources of drift such as mirror resistance changes. Typical sensitivities are on the order of 3 to 5 (cm⁻¹/mA) and 0.8 to 1.0 (cm¹/° C.) for current and temperature, respectively. In order to overcome the stability drawbacks, devices and methods for application of VCSELs as references for interferometry have been developed and are described below.

It has been found that appropriate temperature and current control devices largely eliminate the corresponding sources of VCSEL drift; however, long-term drift of VCSELs, possibly due to aging effects, still presents a problem for interferometric applications. In addition, individual VCSELs can lase at different wavelengths than others even while at the same temperature and drive current. In order to address these issues, a method, which uses a spectral reference and wavelength shift estimation algorithm, was developed to measure and correct the spectral effects of VCSEL shifts. The method and device or subsystem thus preferably includes temperature and current control systems and algorithmic wavenumber shift estimation and correction.

In spectroscopy applications with the present invention, stable spectral resolution and wavenumber axis have been found to be important. Many spectroscopic applications require a minimum analyte signal-to-noise ratio in order for a property of interest to be elucidated. Often, the signal-to-noise ratio of a single scan or acquisition of an instrument does not meet this threshold. In cases where noise is white, one technique that can be used in embodiments of the present invention is to enhance the signal-to-noise ratio by the coherent addition or averaging of multiple equivalent scans or acquisitions. Coherent addition is beneficial when spectral features of a stable sample are substantially constant in intensity, spectral resolution, and wavenumber position. Assuming that the spectral resolution, wavenumber axis, and the wavenumber locations of the discrete spectral data points are consistent across scans, multiple scans of a stable sample can be averaged to reduce spectral noise and correspondingly improve the signal-to-noise ratio.

The improvement in signal to noise is defined by the square root of the number of averaged scans. In cases where the short- or long-term wavenumber stability of the reference laser is poor, chemically and physically non-equivalent spectral values are averaged, which results in a spectrum that does not exhibit the desired signal-to-noise ratio improvement and will appear distorted relative to the individual scans. Depending upon the severity of the wavenumber axis instability, the averaging process can result in a spectrum that demonstrates a degraded, rather than improved, relationship to the desired analytical property of interest (often concentration).

Another reason why wavenumber stability can be critical is the dependence of many spectroscopic applications upon a calibration that relates the instrument response to a chemical or physical property of the sample. For example, the Beer-Lambert law linearly relates the absorption on an analyte at a specific wavelength to its concentration. In order to perform quantitative predictions of analyte concentrations in unknowns, a univariate calibration can be performed by plotting the absorbance values at a specific and consistent wavelength for multiple samples of known composition versus the analyte concentration. If undetected reference laser wavenumber shifts exist between the calibration spectra, the accuracy and precision of the calibration will be degraded because the selected absorbance values used in the calibration will not correspond to their true values.

In a similar manner, for the case of lasing wavenumber shifts between the calibration spectra and prediction spectra, the accuracy of the predictions will be poor because the absorbance values used in the predictions will not represent the same spectral location as the absorbance values used in the calibration. In addition, the absorbance values themselves will not be consistent, regardless of wavenumber position, due to the change in spectral resolution. An example of the error due to a spectral wavenumber axis shift is given in FIGS. 3A, 3B and 3C for a univariate Beer's law analysis.

Four simulated calibration spectra with no wavenumber shifts are shown in FIG. 3A. Points A through D correspond to the absorbance maxima for each of the four simulated spectra. These points, in conjunction with their known concentrations, are used to generate the calibration curve, shown in FIG. 3C. FIG. 3B, however, shows two simulated spectra, which are identical except for the presence of a wavenumber shift between them, whose analyte concentration will be predicted using the calibration curve. Points 1 and 2 in FIG. 3B are the absorbance values of the prediction spectra that correspond to the wavenumber used to generate the calibration curve. Although the two spectra demonstrate the same peak magnitude of absorbance, a prediction error between points 1 and 2 is observed in FIG. 3C. In this case, point 1 yields the correct concentration prediction because its corresponding spectrum has no wavenumber shift relative to the calibration spectra. Point 2 yields a concentration prediction that is below its true value because the absorbance value used for the prediction was not the desired peak maximum. This example shows that if wavenumber shifts are not explicitly corrected for, a prediction error can result.

Similar to univariate analysis, wavenumber axis and spectral resolution shifts in multivariate analysis can result in several undesirable consequences. The observed errors are dependent upon whether the shifts occur during the acquisition of calibration spectra or between the acquisition of the calibration and validation spectra. Shifts that occur within the calibration spectra represent an additional dimension of complexity beyond absorption versus wavenumber that must be modeled. The additional complexity in the spectra requires additional factors to be included into the model to account for the wavenumber and spectral resolution shifts. The additional spectral complexity can result in poorer predictions due to a reduction in net analyte signal (NAS), where the NAS is defined as the portion of the spectrum that is specific for the analyte's concentration levels because it is orthogonal to all other sources of spectral variance.

The effects of a lasing wavenumber shift that occurs between calibration and prediction can be explained by considering the regression coefficients obtained from a Partial Least Squares (or other multivariate) calibration and the spectrum to be predicted. Concentration predictions are generated by vector multiplication of the unknown spectrum and the regression coefficients. The output of this multiplication is the concentration prediction. In this process, the regression coefficients generated from calibration are essentially used to weight the absorbance values in the unknown spectrum. Because each of the regression coefficients corresponds to a specific wavenumber in the spectrum and a specific spectral resolution, a wavenumber shift between the calibration and prediction spectra will result in each wavenumber position in the prediction spectrum being weighted by an inappropriate regression coefficient. An increase in prediction errors can be a direct result of the weighting errors.

Another reason why reference laser wavenumber stability has been found critical in spectroscopy applications of the present invention is qualitative analysis. One of the primary applications of spectroscopy is to determine the chemical composition of samples. Theoretically, each infrared active molecule will exhibit a unique mid-infrared, and therefore near-infrared, spectrum. A molecule's unique spectrum serves as its fingerprint and is used to prove its presence in a sample. Often, chemically similar molecules may have nearly identical spectra that differ only by subtle shifts in peak locations and minute changes in absorbance magnitude. In this situation, undetected shifts in the spectrometer's wavenumber axis or spectral resolution can potentially result in misidentification of unknown samples.

Two principle sources of reference error in an FTIR have been identified. The first of these is a real, but undetected, shift in the laser's emission wavelength. In many infrared applications, the zero crossings of the reference's interferogram are used to digitize the spectral interferogram. The result is a spectral interferogram with all points corresponding to a mirror position that is a multiple of a fraction of the reference's wavelength. This condition not only satisfies a basic requirement for the use of the Fourier transform (FFT) algorithm, but it allows the direct calculation of the spectral wavenumber axis following the Fourier transformation. The equation for the wavenumber axis calculation for a two-sided interferogram is given below.
νᵢ=(i−1)×(2ν_{R}/N) (2)
where νᵢ is the spectral wavenumber corresponding to the i^{th} point of the spectrum, ν_{R} is the wavenumber of the reference, and N is the total number of points in the spectrum. If ν_{R} is not equal to the true reference wavenumber, then the calculated spectral wavenumber axis will be shifted from the true spectral wavenumber axis. Equation 2 shows that the magnitude of the shift error linearly increases with wavenumber in a “stretching” type of effect because νᵢ is calculated by multiplication involving the reference's wavenumber.

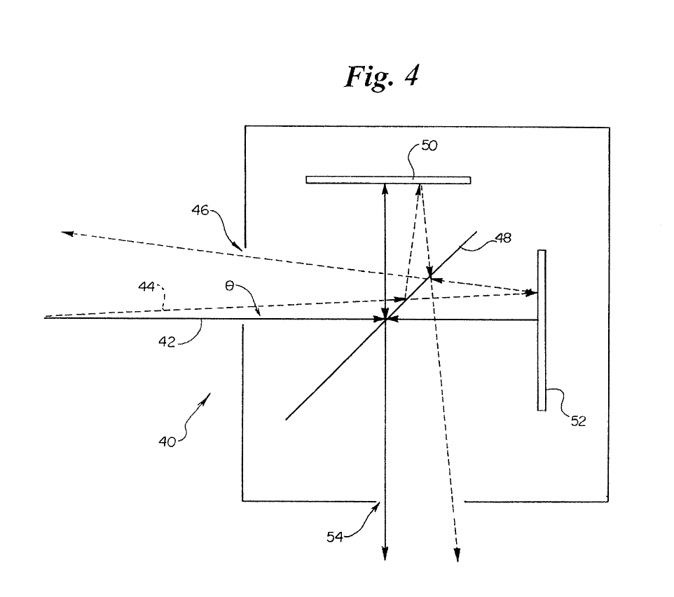

The second source of reference error is an alignment difference between the laser beam path and the spectral beam path. The alignment of the spectral and reference beams affects the accuracy of the wavenumber axis because the internal reference is a true reference only when the perceived wavenumber of the reference relative to the spectral beam is known. In a typical Michelson interferometer, the perceived reference wavenumber and true reference wavenumber are equal only when the reference and spectral beams have exactly the same path lengths through the interferometer. FIG. 4 schematically shows an example of this effect.

FIG. 4 diagrammatically depicts a first beam 42 and second beam 44 passing through an interferometer 40 with an input angle, θ, between them. As depicted, each beam 42, 44 passes through an entrance aperture 46 and engages a beamsplitter 48. A portion of the light energy from each beam 42, 44 is reflected by the beamsplitter and directed to a fixed mirror 50, while the other portion of each beam 42, 44 passes through the beamsplitter to impinge a moving mirror 52. The light energy returning from the fixed mirror 50 and moving mirror 52 is directed to an exit aperture 54. Assuming that both beams 42, 44 are monochromatic and of the same wavenumber, the angle between the two beams is their only difference. The angle results in the two beams having different path lengths through the interferometer 40. Equation 3 shows the relationship between θ and the pathlength difference.

$$X = \frac{2 l}{cos ( θ )} - 2 l \qquad ( 3 )$$

where X is the pathlength difference between the two beams and / is the distance the moving mirror 52 has been moved from zero retardation. A consequence of this path difference is that for values of / other than zero, a phase difference that varies with / will exist between the first beam 42 and the second beam 44. It is this phase difference that will make the apparent wavelength of the second beam 44 longer (and the wavenumber smaller) than that of the first beam 42, although they are known to be identical. Extending this example to a polychromatic beam to represent a spectral beam and considering the beam to be the reference beam shows that any angle between the beams results in an incorrect wavenumber axis.

The spectral resolution of an interferometer is determined by the distance the moving mirror travels from the location of zero path difference. The zero crossings of the reference laser's interferogram allow the precise determination of the moving mirror's location assuming that the lasing wavenumber of the reference laser is accurately known. Each zero crossing is separated from its nearest neighbors by ½ the lasing wavelength of the reference laser. Using the zero crossing spacing and the desired spectral resolution, the number of zero crossings required to achieve the desired spectral resolution can be calculated. In situations where a reference laser wavenumber shift has occurred, the number of zero crossings required to achieve the same spectral resolution will change. Similar to the above wavenumber axis example, any change in the angle between the reference laser beam and the spectral beam will result in a change in spectral resolution.

In an embodiment of the subsystem or device and method of the present invention, features are included in four categories: mode operation, current control, temperature control, and wavenumber shift estimation and correction. It is recognized that features from these categories for the use of a VCSEL reference in interferometry can be considered in any, or in a combination of any, of the methods or elements presented in any of the categories that result in the desired laser wavenumber stability.

VCSELs are available which lase with either a single or multiple modes. Each lasing mode of a VCSEL will exhibit a specific bandwidth that is dependent upon the VCSEL's lattice architecture. The primary requirement of a reference in interferometry is that it must have a sufficiently narrow bandwidth such that the interferometer perceives the wavenumber of the reference to be constant over the entire modulation range (typically mirror travel). The figure of merit for this criterion is the coherence length of the reference. The coherence length is defined as the extent in space over which a light wave behaves sinusoidally. In a Michelson interferometer, a reference laser's coherence length must be longer than the optical path difference required to achieve the desired resolution. One skilled in the art can determine the minimum coherence length for an application using the spectrometers optical configuration, spectral range, and required resolution. From this, the choice between a single-mode and multi-mode VCSEL can be made.

The present invention also includes methods and apparatus that make it possible to use a multi-mode VCSEL as the FTIR reference laser for spectral resolutions higher than supported by the coherence length of the multi-mode VCSEL. The following paragraphs describe an embodiment of a multi-mode VCSEL coupled with a solid Fabry-Perot (FP) etalon to select a single mode and reduce the amplitude of adjacent modes in order to effectively increase the coherence length of the emitted light and thereby support the desired spectral resolution.

In order to be useful as a wavelength reference in an FTIR spectrometer, a VCSEL should have a coherence length long enough to provide sufficient modulation over the entire optical path difference (OPD) range used by the interferometer. The OPD requirements are dependent on the desired spectral resolution. The higher the desired resolution, the greater must be the OPD and the greater must be the coherence length of the VCSEL. A typical 850 nm, multi-mode VCSEL will emit at a number of wavelengths, often over about a 0.85 nm range. Furthermore, the center wavelength of this group might vary from VCSEL to VCSEL over about an 840 to 860 nm range. This kind of VCSEL is suitable for use only in very low-resolution FTIR spectrometers. For example, an instrument with a resolution of 32 cm⁻¹ will require a bandwidth of less than 0.2 nm in order to provide a sufficient coherence length to cover the required OPD range. One way to achieve this coherence length is to use a single mode VCSEL. The single mode VCSEL emits only at a single wavelength, with a bandwidth typically much less than 0.2 nm.

To increase the coherence length of a multi-mode VCSEL, a narrow bandwidth filter can be introduced to select only one of the modes in the multi-mode device. Continuing with the above example, the filter can have a bandwidth of less than 0.2 nm, and at the same time be tunable over the 840 to 860 nm range to match the expected output range of a variety of VCSELs. A multi-layer dielectric filter on a glass substrate can be made with the required bandwidth, and it can be tuned by a few nm by tilting it relative to the propagation axis of the light from the VCSEL. The VCSEL itself can be tuned over a small range by changing its temperature or current. A typical VCSEL, for example, has a temperature coefficient of around 0.06 nm per degree C. and a current coefficient of around 0.4 nm per mA. Since other operating considerations define a narrow acceptable range of current and temperature, it has been found that one cannot tune the VCSEL more than about 1 nm using these parameters. Thus, it is not practical to cover the typical range of wavelengths expected to be encountered in a normal production run of VCSELs. In order to use a filter of this type to select a single mode, the filter would have to be custom made for each VCSEL, becoming an impractical proposition.

An approach is to use a Fabry-Perot etalon. Such devices are well known in the art and characteristic equations describing their performance can be found in many textbooks, such as M. Francon, 1966, Optical Interferometry, Academic Press—New York. A high efficiency FP etalon can be made by placing a multi-layer dielectric reflective coating on the two opposite surfaces of a thin parallel plate of a refracting material, such as glass or fused silica. An FP etalon has the unique property that it can be made to transmit a narrow bandwidth of light at a number of evenly spaced wavelengths simultaneously. This spacing is often referred to as the free spectral range. The free spectral range is determined by the thickness of the parallel plate, and the bandwidth and transmittance are determined by the surface reflectances. Such a device can then be used in the following way: first, choose a plate thickness that will set the free spectral range at slightly greater than the multi-mode bandwidth, and then choose a coating reflectance that will provide a narrow enough bandwidth to give the required coherence length. Continuing with the example above, choose a free spectral range of 1 nm and a bandwidth of 0.2 nm. Using equations found in the cited reference, it has been found one can use a fused silica plate with a thickness of approximately 0.24 mm and a reflectance of about 0.54. Increasing the plate thickness will reduce the free spectral range, and increasing the reflectance will reduce the bandwidth of the passband. All that remains then is to be able to adjust either the VCSEL wavelength or the etalon passband to center the passband on the strongest emission line of the VCSEL. Since the passband opens at intervals of 1 nm, the maximum wavelength adjustment to be made now is 1 nm. This may be accomplished by either adjusting the VCSEL temperature and current or by tilting the etalon. A 4-degree tilt will change the passband center wavelength by around 1 nm. Thus, with the present invention, one is able to select a single mode from the VCSEL without custom building a filter for each VCSEL in spite of the fact that the exact wavelength of operation varies from VCSEL to VCSEL over a large range.

Two restrictions have been found when using an etalon in this way. The first is that the temperature range of operation of the etalon may need to be restricted. Temperature change in general can cause both the refractive index and thickness of the etalon substrate to change, which in turn changes the passband center wavelength. The allowable temperature change will depend on the material chosen for the etalon substrate and on the allowable change in wavelength. In order to minimize this effect, one can choose a material with a low thermal expansion coefficient and a low or negative temperature coefficient of refractive index. If fused silica is selected for the substrate in the example above, a 2.7 degree C. temperature change will move the passband wavelength by about 0.02 nm. This would probably be an acceptable shift for an etalon with a bandwidth of 0.2 nm.

The other restriction is that for good rejection of adjacent modes, the etalon must be used in a beam of light for which the angle of incidence variation on the etalon is small. The acceptable range of angles through the etalon is dependent on the required etalon bandwidth and on the mean angle of incidence on the etalon. The effect of angle divergence through the etalon will be to increase the bandwidth. The passband center wavelength is proportional to the cosine of the angle of refraction inside the etalon plate. Two ways of minimizing the effect of angle variation have been found. One is to operate the etalon with minimum tilt relative to the beam axis, relying more on temperature and current adjustment to match the VCSEL wavelength to the etalon passband. The other is to use a high refractive index material for the etalon plate.

Since choice of etalon material is often dictated by other factors, such as transmittance and thermal coefficients, and since it is believed desirable to be able to use tilt as a means of adjusting the passband center wavelength, an alternative way to reduce the angle of incidence variation of the laser light on the etalon was developed. The divergence angle range of a VCSEL can be a few degrees for some VCSELs. In an FTIR spectrometer application, this range of angles can be reduced to a small value before being directed through the interferometer by a collimating lens. The proper location for an etalon with planar surfaces in this kind of system would be in the collimated portion of the beam. Because the emitting area of a VCSEL is very small, a collimating lens can be very effective in reducing the angle range. For example, in a VCSEL with a source diameter of 15 microns, a divergence half angle of 10 degrees and a perfect collimating lens with a focal length of 6 mm, the beam will have a diameter of about 2 mm and a range of angles in the collimated beam of about plus and minus 0.07 degrees. Continuing with the fused silica etalon described in the example given above, at a tilt angle of 4 degrees the passband would be broadened by about 0.07 nm by this divergence angle range. Although this is a significant fraction of the 0.2 nm design goal bandwidth, it would be acceptable in many cases. The reflectance of the surfaces could also be raised to compensate for this broadening although some reduction in total transmittance of the desired spectral line might be experienced.

Another effective way of reducing the range of angles through the etalon is to build the etalon with spherical surfaces rather than flat surfaces. In this construction, the distance between the two surfaces is made constant by making the radius of curvature of the two surfaces different by an amount equal to the thickness of the etalon, making the surfaces concentric about a common center of curvature. The proper location for this kind of etalon would be in front of the emitter, placing the emitter at the center of curvature. It is still possible to tilt an etalon of this construction to tune the passband center wavelength. The ideal tilt rotation axis will be near the mid point of the etalon, between the two surfaces, in order to minimize lateral translation of the curved surfaces.

Thus by either using a single mode VCSEL or a multi-mode VCSEL in combination with an FP etalon, we can achieve the coherence length necessary to support the desired spectral resolution for the FTIR spectrometer. The next steps in using a VCSEL as the reference laser include determination of the proper current control and temperature control for the VCSEL.

High precision current supplies can be designed using integrated circuits offered by several suppliers. However, for the present application, it has been found that because resistance changes as a function of temperature for most materials, the current delivered by a power supply will vary to some extent with environmental conditions. This variation has been found to be sufficient to cause difficulty in using the VCSEL as a reference laser unless a design criterion is the temperature coefficient of each circuit component. The circuit design itself can also be used to reduce the overall circuit's sensitivity to temperature changes.

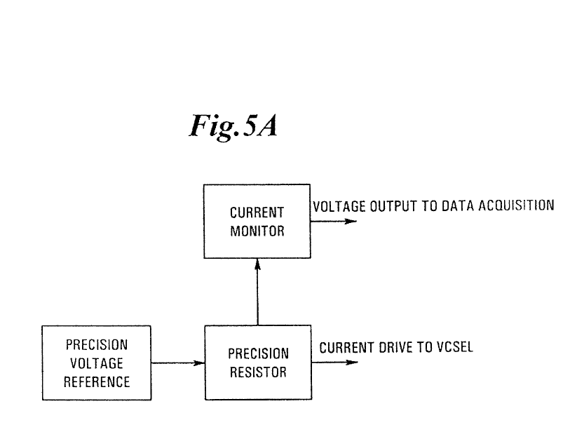

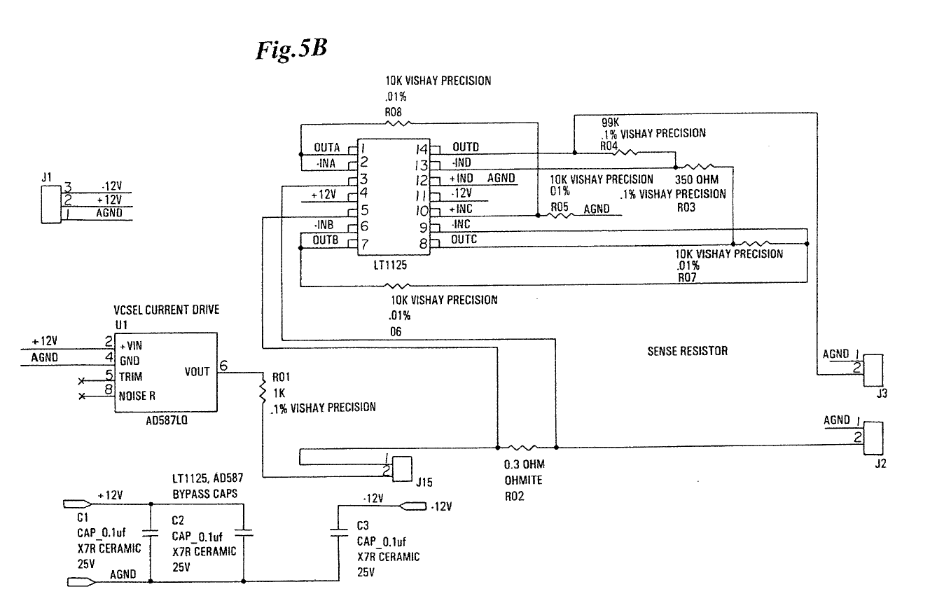

For a current supply for a VCSEL reference in interferometry, the first step has been found to be to determine the minimum current stability requirement using the minimum wavelength stability requirement and the VCSEL's current coefficient. From these values, appropriate circuit components and designs can be chosen such that the total expected environmental drift does not result in drive current variation beyond tolerable levels. FIG. 5A is a general block diagram of a current power supply. FIG. 5A shows a precision voltage power supply that provides input to a precision resistor with low temperature coefficient that converts the output of the precision voltage supply to current. A current monitor is also included in the block diagram. FIG. 5B is a block diagram that shows the key components of an embodiment of a precision VCSEL current supply designed using components with very low temperature coefficients. The circuit design also includes the ability to directly monitor the current delivered to the VCSEL.

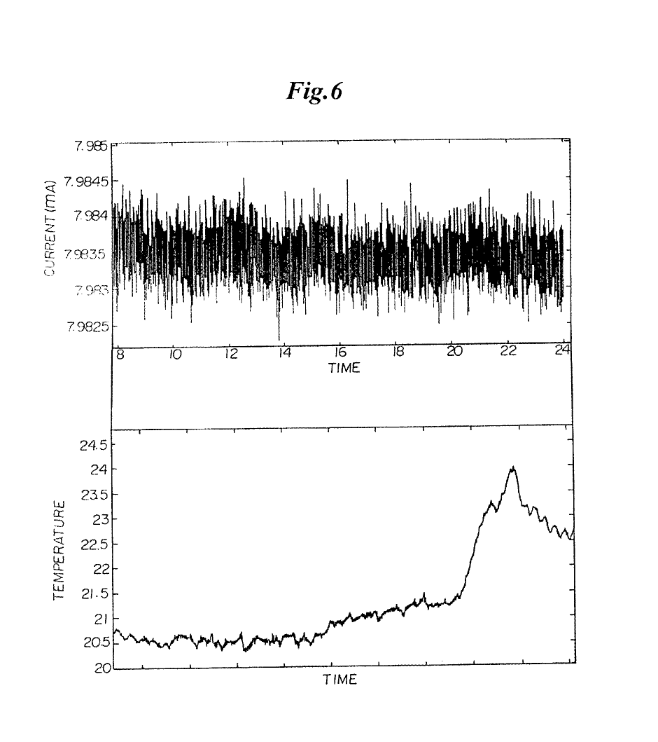

The resistors in FIG. 5B can be constructed from metal foil having about 0.6 ppm or less temperature coefficients, and the integrated circuits are preferably constructed with about 5 ppm or less temperature coefficients. The current output of the circuit can be about 8.00 mA with a stability of about 0.05 μA/° C. based upon the circuit design and component temperature coefficients. Using a typical value of 5 cm⁻¹/mA for a VCSEL current coefficient, the wavelength drift due to current supply drift will be about 2.5×10⁻⁴ cm⁻¹/° C. FIG. 6 shows the monitored drive current supplied to a VCSEL and the corresponding environmental conditions for a test conducted using the drive circuit of FIG. 5B. The plots in FIG. 6 span approximately 10 hours. The noise in the current measurement is a function of measurement noise and is not reflective of the actual current signal to noise. FIG. 6 ilustrates that there is no correlation in current output and ambient temperature. Because VCSELs have been found to exhibit long-term lasing wavenumber drift in addition to drift caused by drive current variation, the current supply need only be stable over a short term. Long-term VCSEL wavenumber stability and the use of an algorithmic correction of VCSEL shifts are discussed below.

Because VCSELs have temperature coefficients on the order of 1 cm⁻¹/° C., they should be temperature controlled in order to insure short-term stability. The two choices for temperature control are to heat and stabilize the VCSEL above ambient temperature, or to cool and stabilize the VCSEL below ambient temperature. Regardless of the choice of heating or cooling, the mechanical design of the VCSEL package of the present invention in some embodiments is such that heat transfer between the cooler/heater and the VCSEL die itself is optimized. The resulting heating/cooling system will demonstrate the tightest control around any desired set point temperature.

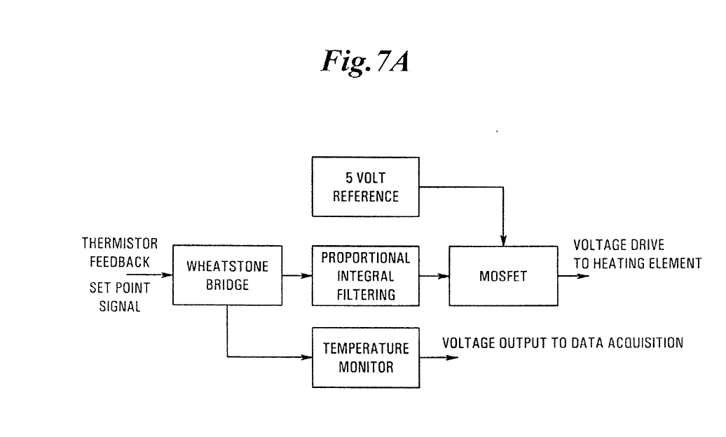

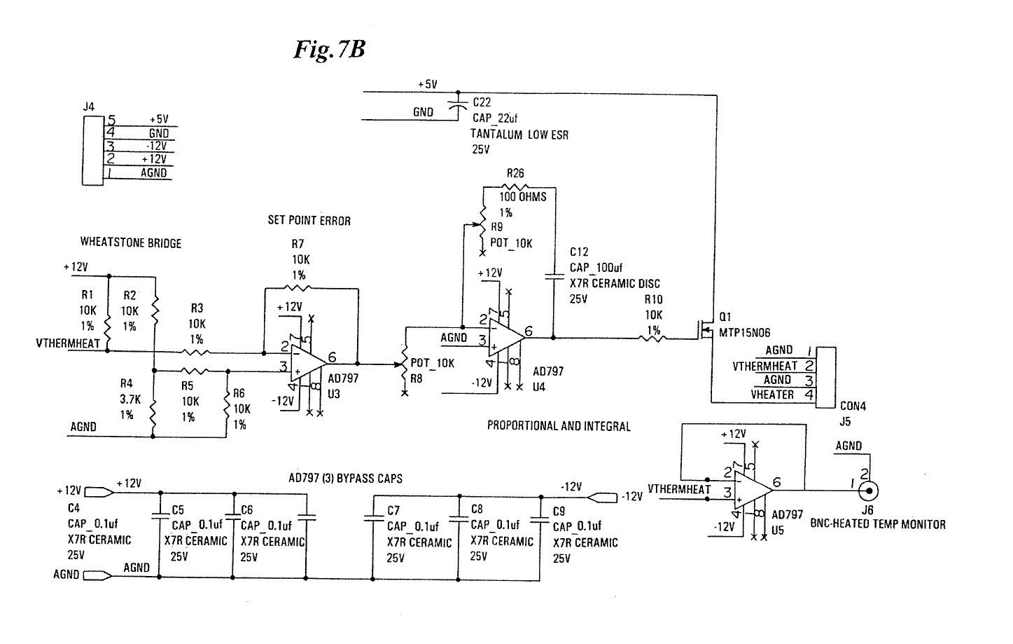

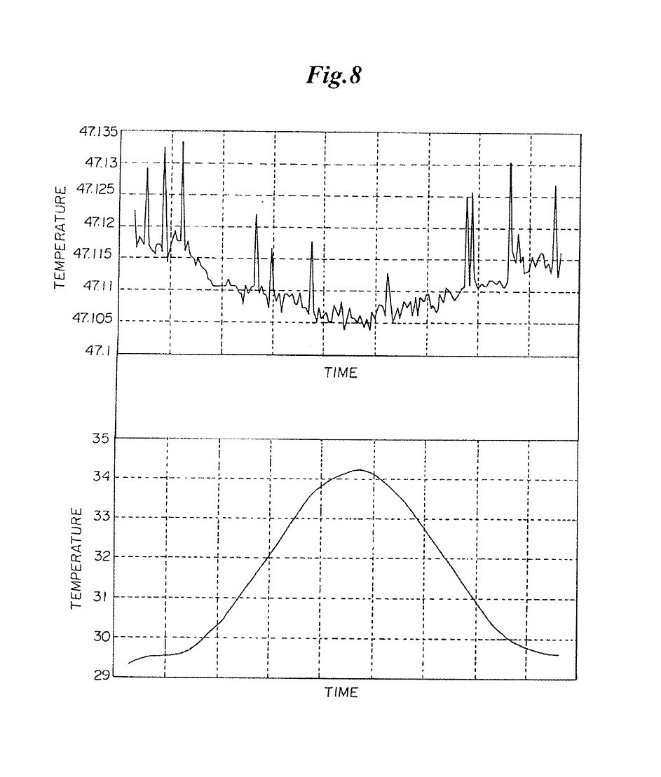

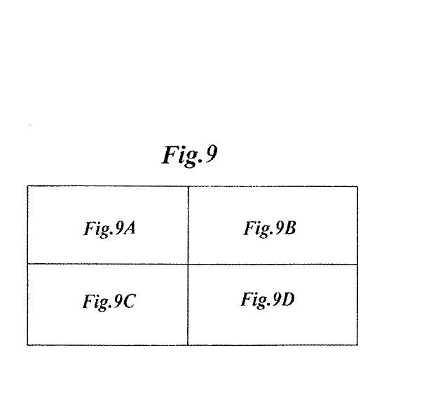

An embodiment of a heated VCSEL package can be obtained using a heating element and a Thermistor feedback control circuit. A block diagram of a general temperature control circuit is shown in FIG. 7A. FIG. 7A shows a temperature measurement device to provide feedback signal to the circuit, a set point signal, a Wheatstone bridge to compare the feedback signal to the set point signal, proportional integral and derivative (PID) filter to provide the control properties of the circuit, a reference voltage supply, and a MOSFET to regulate the output of the circuit using the signal obtained from the PID filter. A temperature monitor can also be included in the circuit. A specific embodiment of a temperature control circuit is shown in FIG. 7B. The amount of heat generated by the heating element is determined by the voltage output of the heating circuit. A Thermistor, or other temperature measurement device, is incorporated into the mechanical design in a manner such that it accurately reflects the VCSEL temperature. The output of the circuit is dependent upon the Thermistor signal such that the output is zero when the Thermistor reads a temperature higher than the set point temperature and maximum voltage when the Thermistor reads a temperature well below the set point. In regions where the Thermistor temperature is near the set point temperature, the circuit output lies somewhere between zero and the maximum output. FIG. 8 shows the measured Thermistor temperature over the course of approximately 18 hours of heated VCSEL operation along with the ambient temperature of the room. The total VCSEL temperature variation over the time period is 0.01° C., which corresponds to a VCSEL lasing wavenumber shift of about 0.01 cm⁻¹ assuming a typical VCSEL temperature coefficient value.

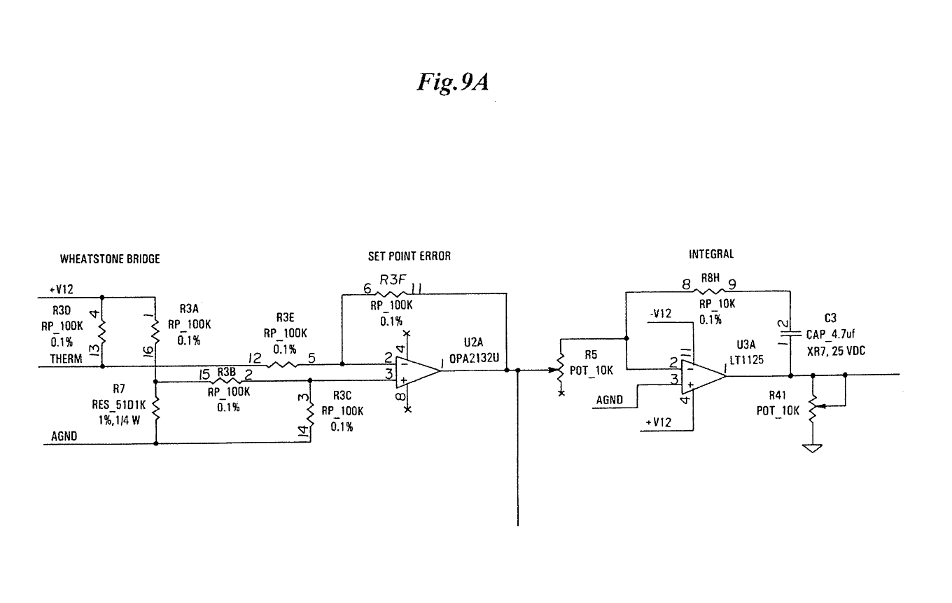

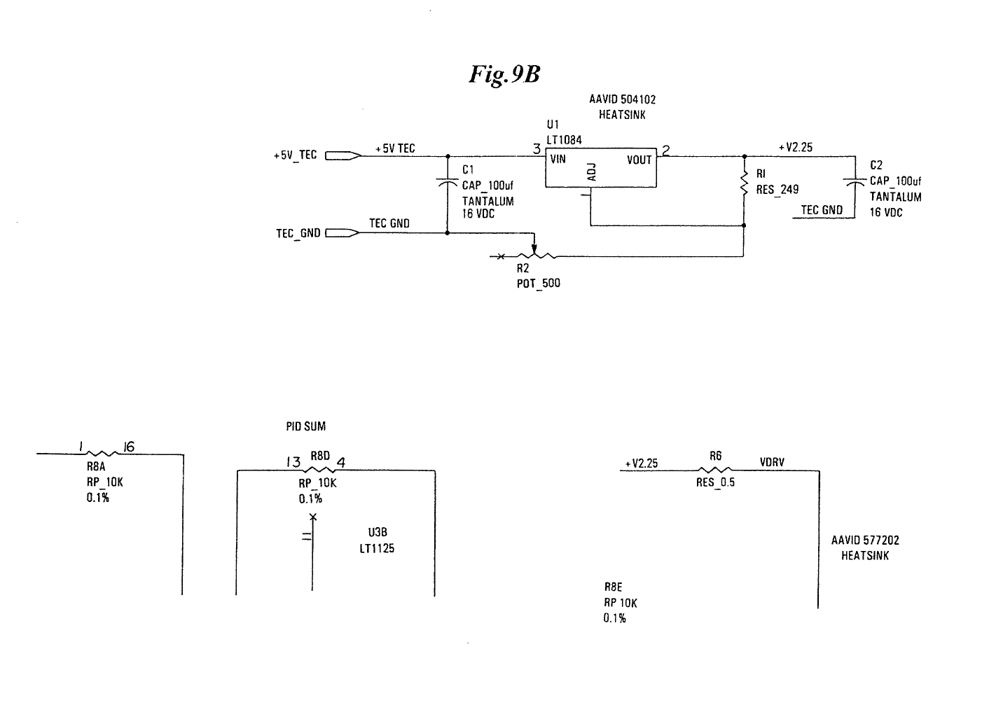

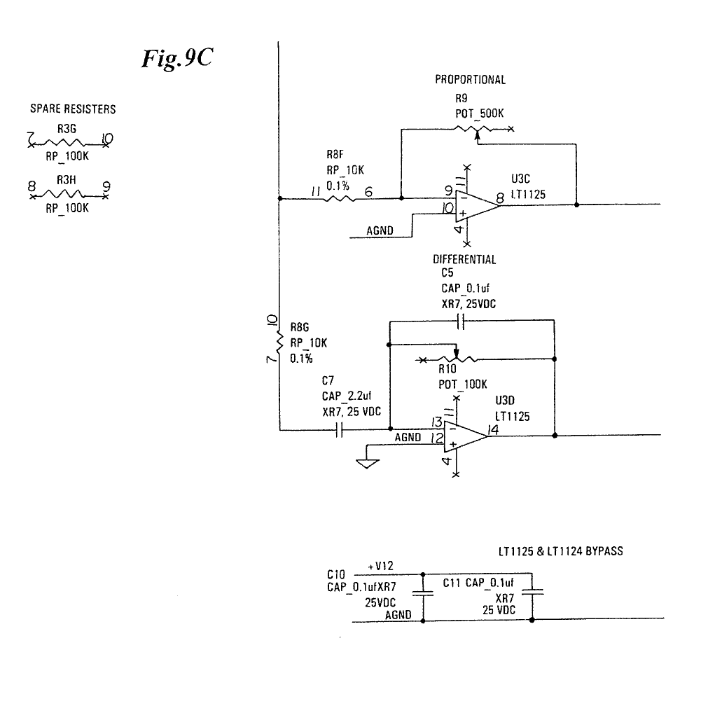

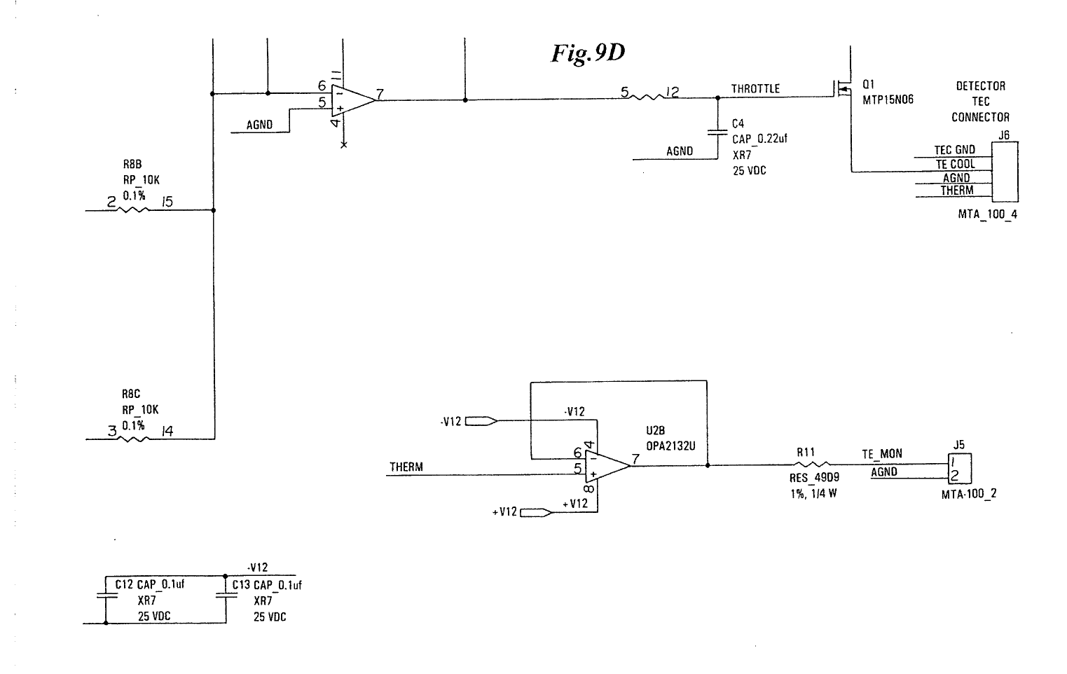

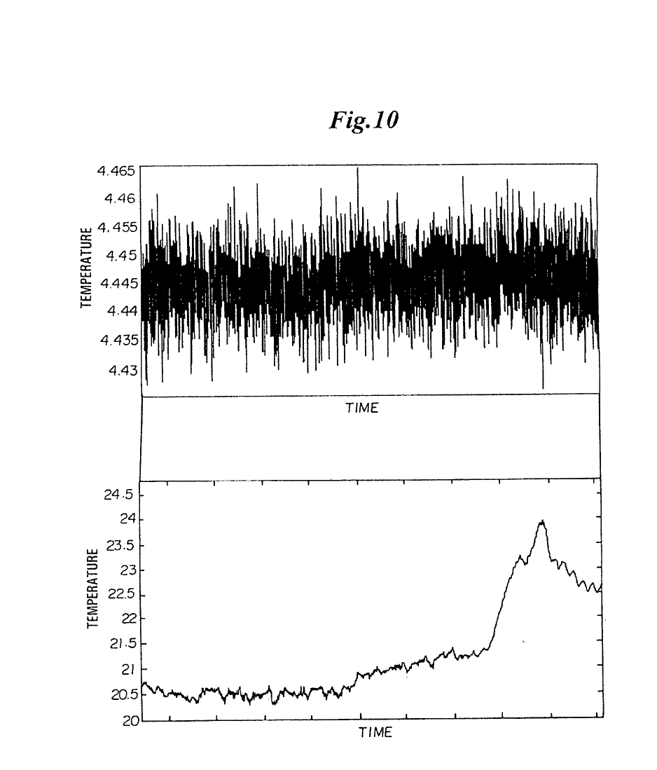

There are several embodiments for a cooled VCSEL package which also rely on Thermistor feedback for temperature control. Thermoelectric (TE) cooling is an embodiment for the VCSEL method and device described here. While FIG. 7A shows a generalized block diagram of a temperature control circuit; FIG. 9 shows a specific embodiment of a Thermistor feedback control circuit that provides power regulation to the TE cooler. Its operation is very similar to the heated control circuit shown in FIG. 7B, with the exception that its temperature response is reversed. The circuit's output is zero when the temperature is below the set point temperature and fully on when the VCSEL is well above the set point temperature. FIG. 10 shows the measured Thermistor response over approximately a 10-hour period along with the ambient temperature over the same time period. The total VCSEL temperature variation over the course of the experiment is 0.005° C., which corresponds to a VCSEL lasing wavenumber shift of 0.005 cm⁻¹ assuming a typical temperature coefficient value. While the performances of the heated and cooled packages are similar, the TE cooled VCSEL package can be preferred because it can be implemented with a smaller total package size and potentially lower cost.

In some embodiments, the subsystem of the present invention includes shift estimation and correction methodology. Shift estimation and correction methodology can detect and remove long-term VCSEL lasing wavelength drift that might occur during its lifetime. The embodiments involve a spectral reference and an algorithm that uses spectra of the reference, which are separated in time in order to detect wavenumber shifts between them. The spectral wavenumber shifts are then used to calculate the VCSEL wavenumber shift. The spectral reference can be any physical or chemical sample or device that demonstrates a single or multiple stable and resolved spectral features over a wavelength region of interest. In one embodiment, a spectrum of this reference is obtained upon the initial installation of the VCSEL in an instrument. This spectrum is then compared to spectra obtained of the spectral reference during the course of its life. In another embodiment, a spectrum of the spectral reference obtained from one instrument is used to provide a means to detect and correct VCSEL lasing wavelength drifts on additional instruments. In this manner, the VCSELs, and therefore the spectral wavelength axes of all instruments, will be corrected to a standard reference.

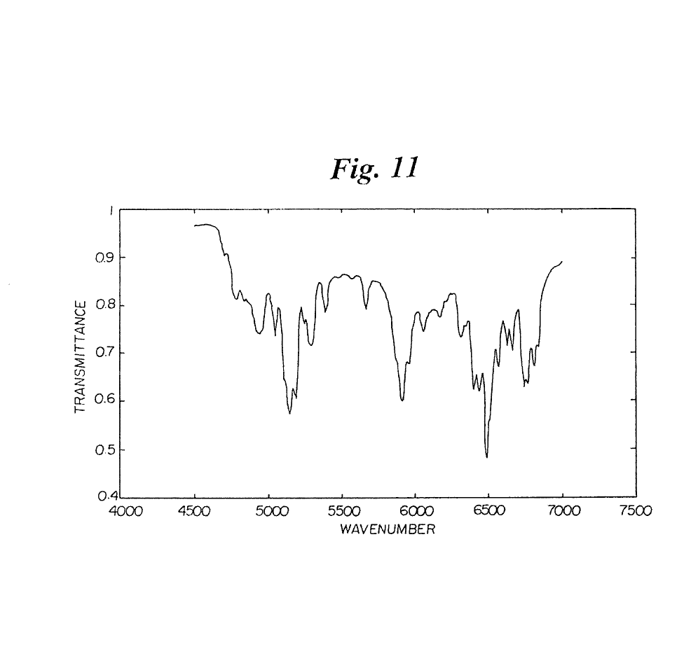

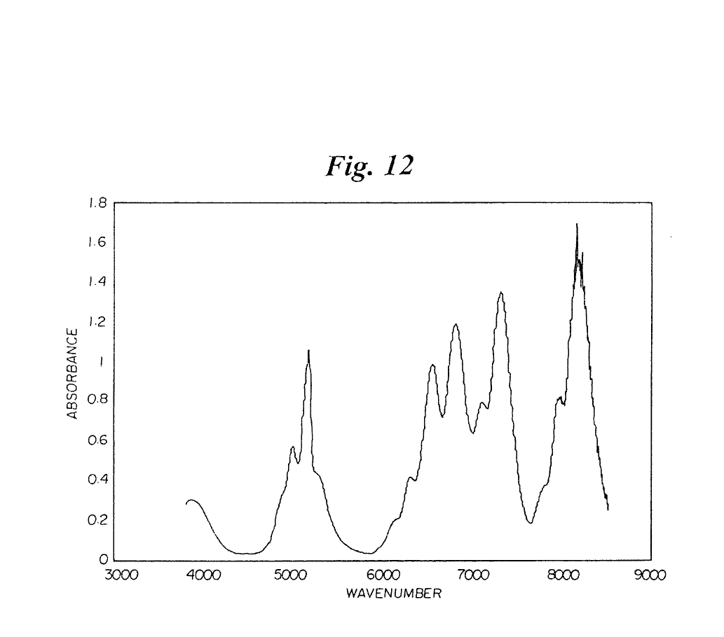

As mentioned above, any chemical sample or mechanical device that exhibits multiple stable and resolved spectral features in the region of interest can be used as a spectral reference or reference sample. The rare-earth series of metal oxides have been found to offer several usable chemical features. Depending upon the wavelength region of interest, different combinations of rare earth metal-oxides can be used to generate a sample that exhibits multiple resolved and stable features. These metal oxides can be subsequently incorporated into a solid, but photometrically transparent, matrix such as spectralon or any other diffusely reflecting material that does not contribute significant spectral features of its own. An example of a spectrum from such a sample is shown in FIG. 11. The material of FIG. 11 is erbium, dysprosium and holmium oxides doped into spectralon. The rare-earth metal oxides can also be incorporated into transmissive materials, such as glass. Careful selection of the glass substrate can ensure that it will not alter or interfere with the spectral features of the metal oxides. FIG. 12 shows a spectrum obtained from a mixture of samarium and holmium doped into a glass substrate.

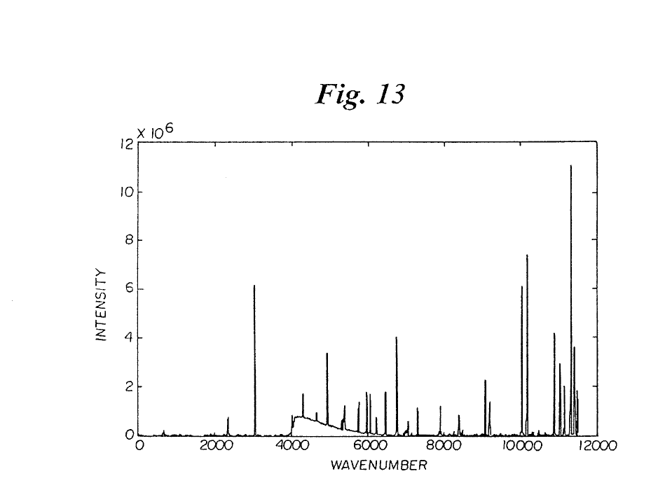

The noble gasses also exhibit spectral features in the near-infrared region. They are atomic emission transitions that are stimulated by heat excitation of the gas. The resulting spectral features are very sharp, less than a wavenumber in the near-infrared region, and demonstrate no background other than the instrument's own response function. Argon, neon, krypton, and xenon have been found to be suitable rare gas emission lamps. A spectrum of xenon is shown in FIG. 13 as a representative example of the spectra of the noble gases.

Physical devices can also be used to provide a spectral reference. For example, Fabry-Perot cavities can be constructed which result in sharp features that are dependent upon the spacing between the sides of the cavity. Multiple cavities can be used simultaneously or in series to provide several features across any spectral region.

In cases where high precision and accuracy of the reference laser are required, the temperature coefficient of the reference sample or spectral reference can be considered. Spectral features that are dependent upon the structure of the molecule or device will vary both in intensity and wavelength position with temperature. In addition, different features from the same sample may exhibit different temperature coefficients. In order to minimize the effects of sample temperature on VCSEL lasing wavelength shift estimation, the temperature coefficient of each spectral feature is determined, and a subsequent correction is applied.

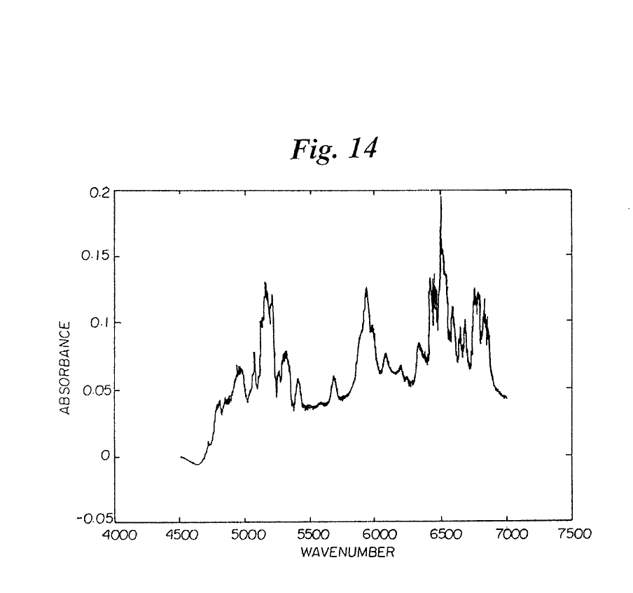

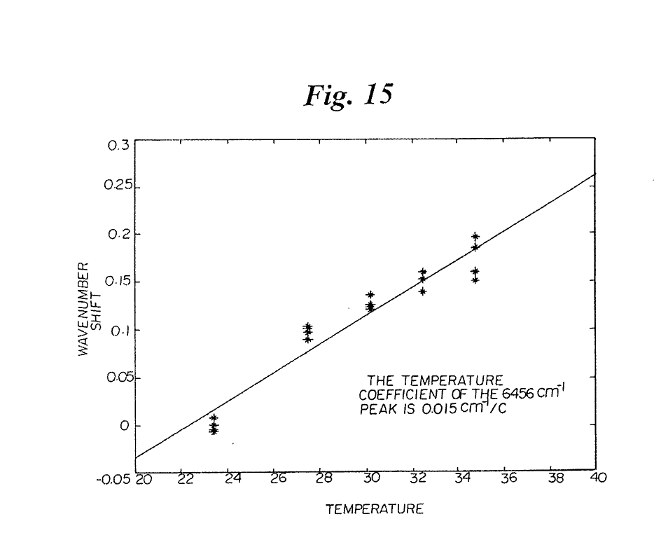

The temperature coefficient of each spectral feature can be obtained using an interferometer where reference laser drift is negligible. A helium-neon laser can fulfill this requirement. Spectra of the chemical or physical sample or device are then obtained over a range of temperatures. Temperature coefficients, which indicate the wavenumber positional sensitivity of a spectral feature to temperature changes, can then be calculated for each feature in the spectra. FIG. 14 shows the spectra obtained of rare-earth doped spectralon over a range of temperatures using a temperature controlled interferometer with a helium-neon reference. FIG. 15 shows the temperature versus wavenumber shift for the 6456 cm⁻¹ spectral feature. Table 1 below shows the temperature coefficients for several features of the spectra in FIG. 14 that were calculated from plots similar to FIG. 15.

TABLE 1

| Peak Location (cm⁻¹) | Temperature Coefficient (cm⁻¹/C) |
|---|---|
| 4854 | −0.010 |
| 4943 | 0.015 |
| 5071 | −0.004 |
| 5158 | −0.007 |
| 5686 | 0.000 |
| 6083 | −0.003 |
| 6425 | 0.014 |
| 6456 | 0.015 |
| 6469 | 0.000 |
| 6508 | −0.005 |
| 6529 | −0.021 |
| 6567 | −0.041 |
| 6590 | −0.040 |
| 6646 | −0.012 |
| 6683 | −0.033 |
| 6836 | −0.053 |
| 6861 | −0.058 |

The present invention can include or function with an embedded computer system or other electronic means that includes an algorithm to provide shift estimation and correction. The purpose of the algorithm is to accurately measure any wavelength position change of one or multiple features in a spectral reference. This can be accomplished through comparison of two spectra of the same spectral reference that are taken at different times. The concept is to compare a spectrum of the reference sample obtained upon initial instrument assembly and calibration, or later recalibration, to future spectra of the same sample throughout the instrument's life. The positional change of features between the original and future spectra is used to calculate the drift in the reference laser's true lasing wavenumber. Subsequent spectra of any sample type are then corrected to the instrument's original reference laser wavenumber by accounting for the estimated laser shift.

The shift estimation is accurate provided the peak locations of the spectral features are accurately measured. There are several methods for determining the wavenumber location of the peak of a spectral feature. The maximum value around the feature, center of gravity, and up-interpolation followed by maximum value determination are a few methods that can be used to estimate the wavelength location of the peak of a spectral feature, as is known in the art.

One embodiment of peak location estimation for this invention involves up-interpolation of the spectrum and subsequent calculation of its first derivative. The spectral peak maxima correspond to zero crossings in its first derivative. In addition, the regions near zero crossings can be accurately represented by lines. Consequently, the wavenumber location of the zero crossings, and therefore the spectral peaks, can be calculated using a linear interpolation between the two points that bound the zero crossing. Each pair of points is used to calculate a slope of the line they form. The zero crossing can be calculated from each slope and one of the points.

In order to improve laser drift estimation accuracy, it is desirable, but not required, to include multiple spectra features in the shift estimation calculation. This is because spectral signal to noise and changes in environmental conditions contribute uncertainty to the estimation of the true peak location of each feature. Inclusion of multiple features can help to reduce the uncertainty through a regression mechanism.

The laser shift estimation accuracy is defined by a combination of the number of reference spectral features, their signal to noise, and their temperature coefficients. In cases where the signal to noise of the reference features is low or the effects of the reference feature's temperature coefficients cannot be sufficiently corrected, additional reference features may be required. Consequently, there is no set minimum number of features, minimum temperature coefficients, or signal to noise. The selection of the values for these parameters is ultimately dependent upon the wavenumber shift sensitivity of the specific spectroscopic application under investigation.

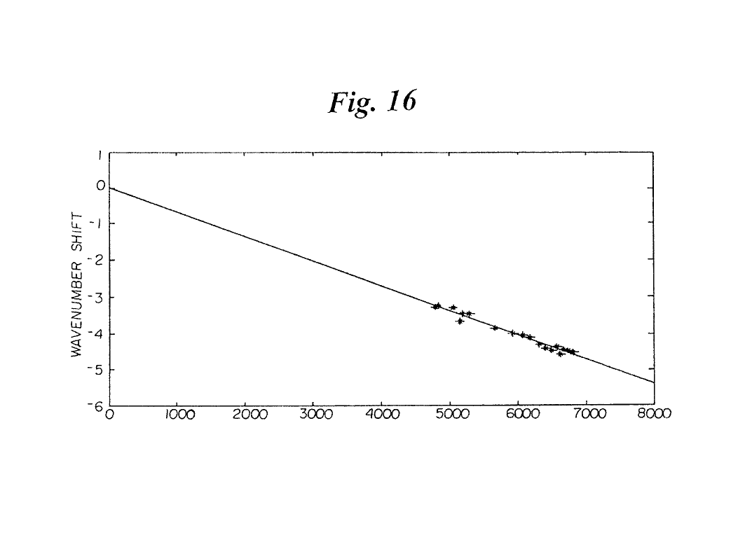

Equation 2 shows that a shift in the reference laser's emission wavenumber will affect larger spectral wavenumbers more than smaller spectral wavenumbers. This relationship is linear, such that the spectral shift at 8000 cm⁻¹ will be twice that of 4000 cm⁻¹. Consequently, once the peak locations of the spectral reference's features for both the original and comparison spectra are determined, a linear regression of the spectral feature shifts and Equation 4 are used to determine the reference laser's shift.
Δν=βνₒ (4)
where Δν is the reference laser's shift, β is the slope of the linear regression, and νₒ is the known lasing wavenumber from the original instrument calibration. FIG. 16 graphically depicts an example of the linear regression used to calculate β. At zero wavenumbers, the shift must be zero. This is a known point in the regression.

In some applications, the effects of a reference laser wavenumber shift on spectral resolution are not a concern. In such applications, Equation 2 can be used to generate a new spectral wavenumber axis, which corresponds to the current instrumental conditions, that is applied to future spectra of any sample type. While the spectra will be accurate in terms of the wavenumber axis, the discrete data points will not correspond to the wavenumber locations of the original calibration spectra. In order to allow the shift-corrected spectra to be directly comparable to the original spectra and allow predictions of chemical information from the original calibration model, a final spectral interpolation can be used to find the spectral values that correspond to the wavenumber positions of the discrete data points in the original calibration spectra. Cubic, spline, or other shape-sensitive interpolation methods are acceptable embodiments for this final step.

In applications where shifts in both the wavenumber axis and spectral resolution are of concern, the spectral interferograms themselves can be corrected. In this type of correction, the VCSEL shift estimate can be used to determine the zero crossing separation in the spectral interferogram. The zero path difference location can be determined and used with the zero crossing separation to calculate the mirror position for each point in the spectral interferogram. Using this information, the interferogram intensity values at the mirror positions corresponding to the original calibration can be interpolated. Cubic, spline, or other shape-sensitive interpolation methods are acceptable embodiments for this final step.

An embodiment of the complete VCSEL method and device or subsystem of the present invention includes a single mode 850 nm VCSEL, a precision current supply with short term stability better than 0.05 μA/° C., a TE cooled package with temperature stability of better than 0.005° C., the derivative/regression based shift estimation and correction method, and a rare-earth doped spectral reference which can be either diffusely reflecting or transmissive in nature. In order to evaluate the invention's performance, a complete VCSEL method and device was assembled using the components and methods outlined above. An exception is that the precision current supply was designed to provide a tunable output. Using this tunable current supply, known and stable VCSEL lasing wavenumber shifts were induced that resulted in corresponding spectral shifts. The known lasing wavenumber changes allowed the direct evaluation of the performance of the entire VCSEL package.

A set of solutions containing glucose, ethanol, urea, water, creatinine, and polystyrene scattering beads was generated in order to perform the evaluation of the VCSEL method and device. Using the above-described VCSEL package, spectra of the solutions and rare-earth doped spectralon were obtained and a Partial Least Squares (PLS) calibration model for glucose was generated. These initial spectra and model were obtained with a stable VCSEL current, and therefore contained no induced VCSEL wavenumber shifts. This represents the control case for baseline prediction performance and spectral variation analysis using principle components analysis (PCA).

Spectra of the same solutions were then obtained in the presence of induced VCSEL wavenumber shifts. Each time the current supplied to the VCSEL was changed; a spectrum of spectralon doped with rare-earth oxides was taken. These spectra were then used in conjunction with doped spectralon spectra obtained in the first calibration to estimate shifts and determine the appropriate corrections. Again, PCA was used to evaluate spectral variation, and a PLS glucose calibration model was used to determine the effects of the VCSEL wavenumber shifts on glucose concentration predictions. Finally, a set of validation solutions of similar, but different, composition was generated and their spectra were obtained in the presence of VCSEL shifts. The two models were used to predict the new spectra in order to determine the effects of shifts in true validation.

Finally, the spectra used in the second calibration were corrected using the described VCSEL shift estimation and correction methodology, and a third PLS calibration was generated. In addition, the validation spectra were also corrected and predicted using the three models. Table 2 below shows a summary of the PLS cross-validated standard errors of prediction (CVSEP) for the three calibrations models and the true validation SEP for several model-validation set combinations. Examination of Table 2 shows the CVSEP for the stable calibration is 4.39 mg/dl, which represents the benchmark for the correction methodology. The CVSEP of the varied current calibration is poorer due to the additional spectral complexity resulting from the wavenumber shifts. The CVSEP of the corrected spectra is almost identical to the stable calibration. In true validation, the predictions are poor when uncorrected spectra are involved either in calibration or validation. The SEP of the corrected validation being predicted by the stable calibration model is 5.3 mg/dl, which compares very well to the CVSEP of 4.39 mg/dl for the stable calibration. The uncorrected validation spectra predict very poorly with the stable calibration whose corresponding SEP is 408.3 mg/dl. The prediction results for the corrected spectra clearly demonstrate the effectiveness of the VCSEL method and device for removing the effects of reference laser shifts.

TABLE 2

| Calibration/Validation | SEP (mg/dl) |
|---|---|
| Current Stable Calibration/Cross Validation | 4.39 |
| Varied Current Calibration/Cross Validation | 5.07 |
| Shift Corrected Varied Current Calibration/Cross Validation | 4.43 |
| Current Stable Calibration/Uncorrected Validation | 408.3 |
| Current Stable Calibration/Corrected Validation | 5.3 |
| Varied Current Calibration/Uncorrected Validation | 17.5 |
| Varied Current Calibration/Corrected Validation | 6.5 |

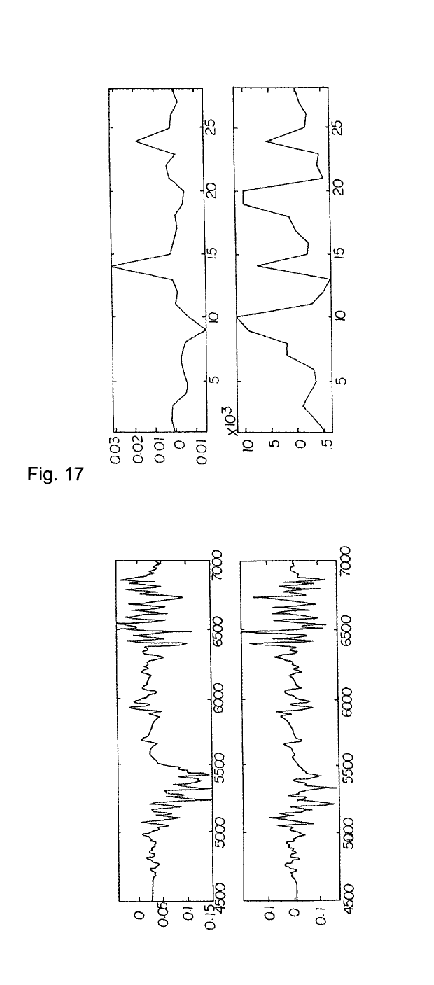

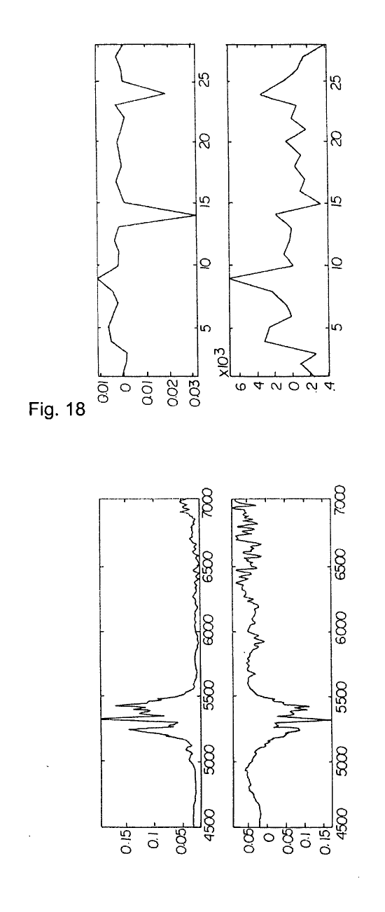

FIG. 17A shows the first two PCA eigenvectors and scores for the rare earth doped spectralon spectra obtained during the second calibration before correction. FIG. 17B shows the same data after correction. Notice that the derivative-shaped eigenvectors, which indicate the presence of wavenumber shifts, are gone for the corrected spectra in FIG. 17B. The eigenvectors of the corrected spectra primarily exhibit water vapor variance due to changes in ambient humidity. The combination of the PCA and PLS results show that the VCSEL method and device of the present invention results in a laser reference that exhibit qualitative and quantitative performance that is substantially similar to a helium neon laser reference. Therefore, the invention represents a viable substitute or replacement for the HeNe laser while simultaneously offering significant commercial advantages.

Wavelength Stabilization

A Fabry-Perot etalon, placed in the collimated VCSEL optical path, can also be used as a wavelength maintenance device. This can be either the same etalon used for mode selection, as previously described, or it can be a second etalon in series with the first, optimized for the purpose of wavelength maintenance. The choice can depend on such parameters as the VCSEL tuning range and the most economical way to achieve a narrow bandwidth desired for wavelength maintenance.

Although an etalon is not an absolute wavelength reference in the same sense as a series of gas emission lines or rare earth oxide absorption lines, its long-term passband stability can be used to correct the VCSEL wavelength to a fixed value in spite of such factors as long term current source, or temperature drift resulting from component aging. While these factors can be corrected using gas emission lines or oxide absorption lines as described elsewhere in this disclosure, it can be desirable to have an alternative scheme to employ when these methods are not available. For example, incorporating a permanently installed etalon calibration maintenance device can allow a single absolute wavelength calibration, using emission or absorption standards during the initial instrument manufacture or at infrequent intervals. This can reduce the instrument cost by not having to incorporate one of these other standards in each instrument.

In the previous example a mode selection etalon was designed to have a free spectral range slightly larger than the total bandwidth containing all of the VCSEL modes. Tilting the etalon, along with current or temperature adjustment, can be used to accommodate the wavelength variations from one VCSEL to the next. In addition the etalon had a passband width of less than or equal to that required to produce the coherence length required to support the desired instrument resolution. In some cases, the most desirable etalon free spectral range and bandwidth for use as a wavelength maintenance device may be smaller than that required for coherence length control. Although coherence length requirements can be met even when more than one mode is present in the filtered VCSEL output, a desirable bandwidth for precise wavelength maintenance is one which will pass only a single mode of the VCSEL.

When both mode selection and wavelength maintenance are desired two etalons can be used in series. The first, used for mode selection, need only to have a bandwidth less than or equal to the free spectral range of the second. The second etalon, used for wavelength maintenance can then have a narrower bandwidth, isolating a single mode. Another desirable feature of an etalon used for wavelength maintenance is that it be used near normal incidence. The reason for this is that the effect of angle changes on the center wavelength of the passband is minimized near normal incidence, thereby minimizing the effect of any angle changes due to, for example, warping of the mechanical structure holding the etalon. A small tilt is, nevertheless, desirable to prevent VCSEL instability caused by back reflection of the emitted light. For purposes of wavelength maintenance it can be desirable to control the temperature of the etalon to a tighter tolerance than when it is used only for coherence length control. Some multi-mode VCSELs have a large current tuning range that might allow them to be tuned over a range that is greater than the total bandwidth of all modes. In this case a single etalon with a free spectral range equal to or greater than this bandwidth could be used both for the purpose of mode selection and wavelength maintenance without the necessity of using large tilts for tuning.

As a design example, an etalon was constructed from 1 mm thick fused silica with surfaces parallel to about 1 arc second. The two surfaces were each coated with a multi-layer dielectric film resulting in a surface reflectance of about 73%. When tested, this device had a free spectral range of about 3.5 cm−1 and a half amplitude bandwidth of 0.4 cm−1. Transmittance at the passband peak was about 90%. Temperature was maintained to better than 0.05° C., at a convenient set point above the ambient environment temperature, giving a passband peak stability of better than 0.0035 cm−1. This etalon was used in conjunction with a VCSEL having a current tuning coefficient of about 3.5 cm−1 per mA. Thus, the VCSEL could always be tuned to the nearest passband peak with a current change of 1 mA or less. Since this current range was well within the allowable operating range of the VCSEL no tilt tuning was required but the etalon was operated with a small tilt to prevent optical feedback into the VCSEL.

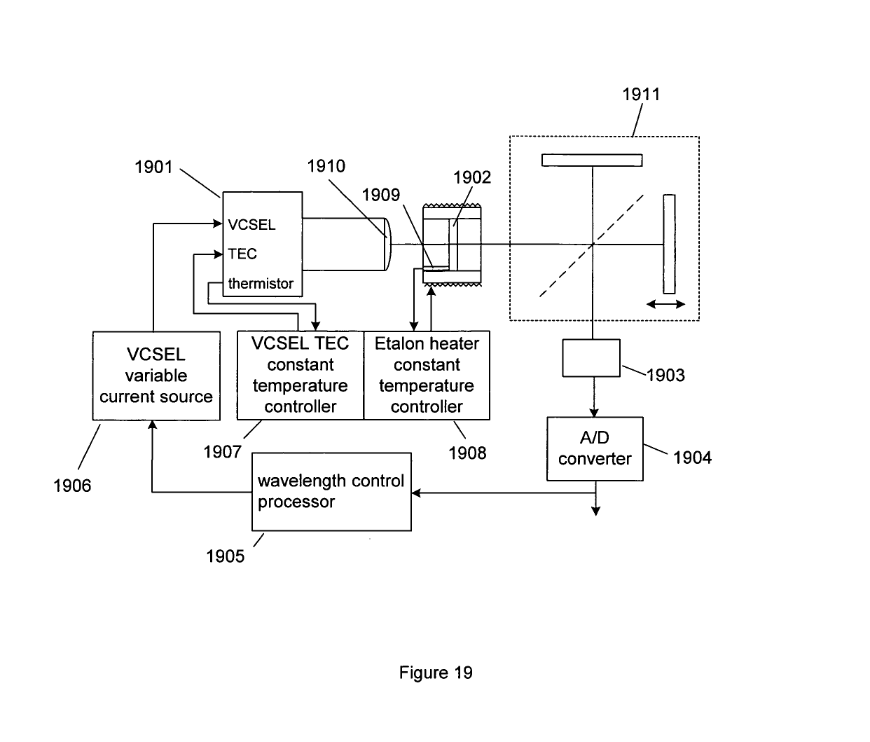

The etalon can be used in several ways as a wavelength maintenance device. It can be placed somewhere in a path between the VCSEL and a photodetector. This can be the main path through the interferometer or, in some cases, an auxiliary path created by a beam splitter. Also, in all cases the amplitude of the light going through the etalon or reflected from it is measured as a function of a VCSEL operating parameter, such as current or temperature, to determine the VCSEL wavelength as a function of the transmission or reflection characteristics of the etalon. FIGS. 19-22 and 24 show several example configurations in which a wavelength maintenance etalon is incorporated into the reference channel of a Fourier transform spectrometer. For clarity, only the VCSEL reference path is shown and only a single etalon is shown. These are intended for illustration only and do not represent all possible configurations.

In FIG. 19 a VCSEL 1901 and collimator 1910 produce collimated output light. The collimated output light passes through an etalon 1902 and thence to an interferometer 1911. A detector 1903 detects light from the interferometer 1911. An analog-to-digital converter 1904 can be used to digitize the output of an analog detector. A wavelength control system 1905 receives a signal from the detector 1903 (in the figure, after digitization by the analog-to-digital converter 1904). The wavelength control processor 1905 can control an operating parameter of the VCSEL 1901 to establish the VCSEL output wavelength at a desired value, adjusting the operating parameter so that the signal from the detector 1903 indicates that the wavelength, as passed by the etalon 1902, is appropriate. In the figure, the temperature of the etalon is monitored by a thermistor 1909 and controlled 1908 to maintain consistent etalon operating characteristics. The temperature of the VCSEL is similarly controlled 1907. The wavelength control system 1905 thus can control the output wavelength of the VCSEL 1901 by controlling the energy used to drive the VCSEL 1901, for example by controlling a variable current source 1906. In the system of the figure the amplitude of the light on the detector 1903 will be proportional to the wavelength of the VCSEL 1901 relative to the transmittance vs. wavelength curve of the etalon 1902. It will also be modulated by the interferometer 1911 OPD scanner. In some cases it is desirable to be able to ignore this modulation due to the OPD scanner and look only at a signal proportional to the average amplitude through the etalon 1902. This can be done in a variety of ways including processing the digitized signal to determine the peak-to-peak amplitude over a portion of the scan or measuring the average or DC signal level over the entire scan or a portion of it.

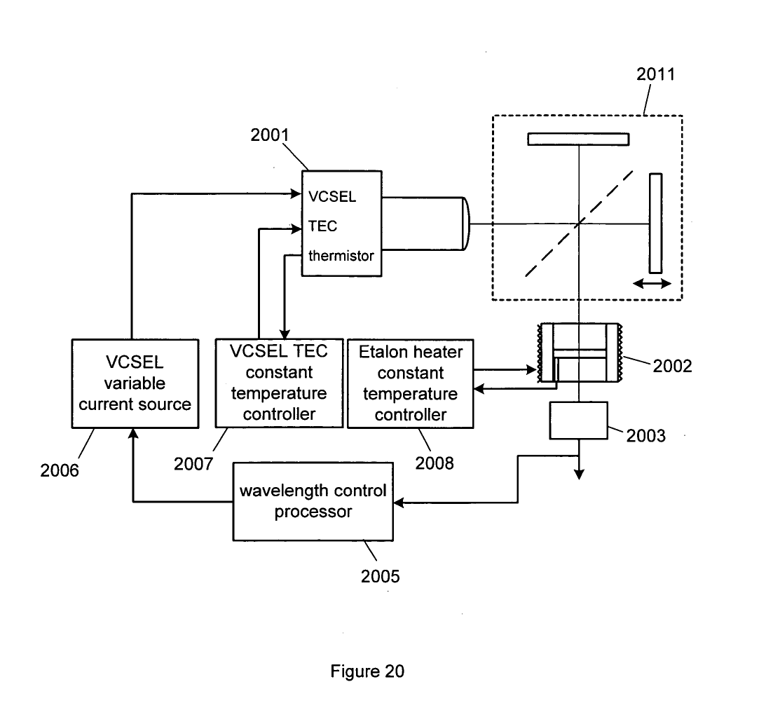

In FIG. 20 an etalon/collimator subsystem 2001 generates collimated output light, which is directed to an interferometer 2011. Light from an output port of the interferometer 2011 is directed to an etalon 2002, and thence to a detector 2003. An output signal from the detector 2003 can be used in processing the interferometer information. An output signal from the detector 2003 can also be used as an input to a wavelength stabilization system 2005. The wavelength control system 2005 can control an operating parameter of the VCSEL 2001, such as drive current or operating temperature, to control its output wavelength. As an example, the wavelength control system 2005 can control the output wavelength of the VCSEL 2001 by controlling a variable current source 2006. In the system of the figure the amplitude of the light on the detector 2003 will be proportional to the wavelength of the VCSEL 2001 relative to the transmittance vs. wavelength curve of the etalon 2002. It will also be modulated by the interferometer 2011 OPD scanner. In some cases it is desirable to be able to ignore this modulation due to the OPD scanner and look only at a signal proportional to the average amplitude through the etalon 2002. This can be done in a variety of ways including processing the digitized signal to determine the peak-to-peak amplitude over a portion of the scan or measuring the average or DC signal level over the entire scan or a portion of it.

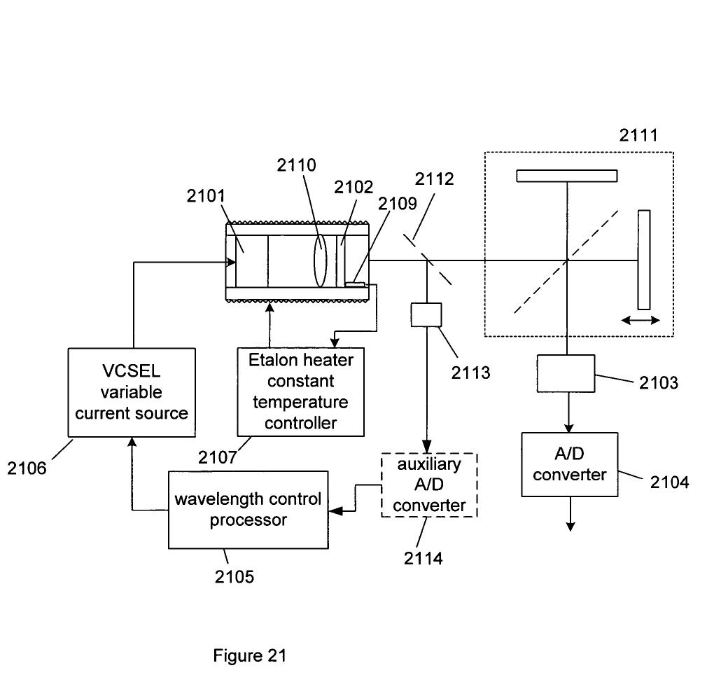

In FIG. 21 the VCSEL/etalon signal amplitude is detected before modulation by the interferometer. A VCSEL 2101, collimating lens 2110, and etalon 2102 are mounted in a common package. The temperature of the package can be monitored with, for example, a thermistor 2109 and controlled 2107 to foster consistent operating characteristics. Light from the etalon 2102 impinges on an auxiliary beam splitter 2112, which defines a first optical path to an interferometer 2111 and thence a detector 2103 and analog-to-digital converter 2104. Auxiliary beam splitter 2112 also defines a second optical path to an auxiliary detector 2113. A signal from the auxiliary detector 2113, optionally digitized by an analog-to-digital converter 2114, serves as an input to a wavelength control system 2105. The wavelength control system 2105 can control an operating parameter of the VCSEL, for example a variable current source 2106, to adjust the output wavelength of the VCSEL 2101. In the system of the figure the amplitude of the light on the auxiliary detector 2113 will be proportional to the wavelength of the VCSEL 2101 relative to the transmittance vs. wavelength curve of the etalon 2102. The wavelength control system 2105 accordingly can adjust the drive current to the VCSEL 2101 to adjust the output wavelength such that the signal from the auxiliary detector 2113 displays the corresponding characteristics (e.g., is at a maximum if the desired output wavelength corresponds to a maximally-transmitted wavelength of the etalon 2102).

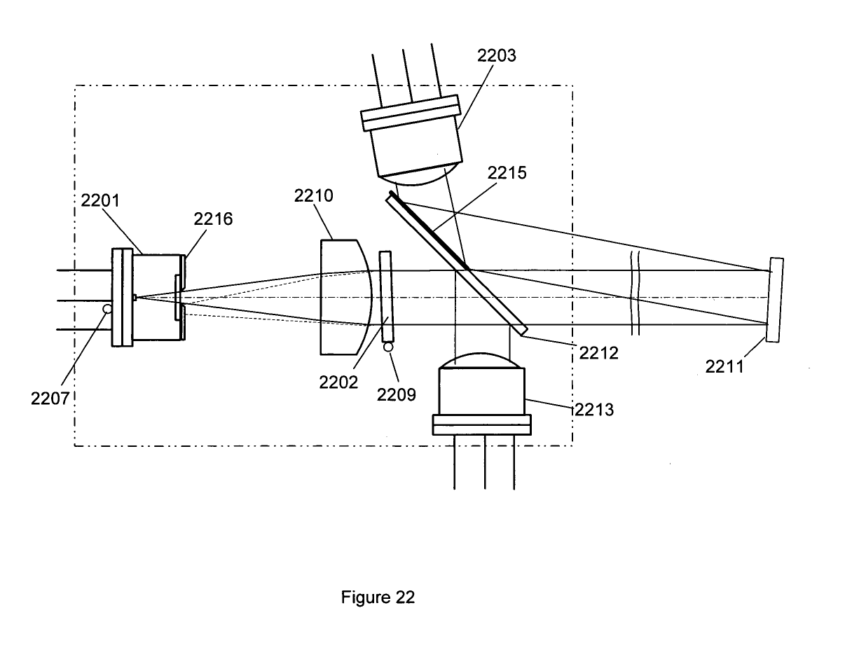

FIG. 22 illustrates an arrangement in which a VCSEL, etalon, beam splitter and two photodetectors can be included in a single temperature controlled package providing both an OPD modulated signal and an unmodulated signal. For clarity a heating element encompassing the package is not shown. A VCSEL 2201 can have a thermistor 2207 for temperature control mounted with it, and an aperture 2216 mounted with it to prevent undesirable reflections. Light from the VCSEL 2201 can be collimated by a collimator 2210. The collimated light can pass through an etalon 2202, with optional thermistor 2209 for temperature control. The etalon 2202 can be tilted, for example by about 1.5 degrees, to discourage reflections from passing the aperture 2216 and interfering with the operation of the VCSEL 2201. A beam splitter 2212 can separate the light from the etalon 2202 along two paths. A first path is directed to an interferometer, whose optics are configured such that returning light reaches a mirrored surface 2215 before reaching a detector 2203 whose output is modulated by the interferometer. A second path is directed to an auxiliary detector 2213, whose output is not modulated by the interferometer. Either, or both, of the detector outputs can be used for wavelength control such as that described above.

In these illustrations an etalon is used in transmittance. Other configurations are possible in which the etalon itself can be used as a beam splitter, reflecting light onto a photodetector. An etalon with reflective dielectric coatings will have minimum reflectance when the transmittance is maximum. An important characteristic of all these configurations is that a voltage proportional to the VCSEL wavelength vs. etalon passband characteristics can be recovered for the purposes of wavelength control.

When two etalons are used, as in the case where it is desired to use one for coherence length control and the other for wavelength control, they can both be in the path of the light going through the interferometer, as in FIGS. 19, 20, 21, 22, and 24. They can be placed in the optical path between the VCSEL and a photodetector in any order. It is also possible to place only the coherence length control etalon in the interferometer path, in which case it is important that it also be in the path before the wavelength maintenance etalon. If only the coherence length control etalon is placed in the interferometer path there is a risk that if more than one mode is allowed to pass any small change in the relative amplitude of the various modes will cause an apparent change in the VCSEL wavelength in spite of rigid wavelength control by the second etalon.

If the VCSEL current or temperature is changed in a systematic way, so as to tune the wavelength across the passband of the etalon, the amplitude of the light on the detector will change in response to the passband shape. The response vs. current or temperature can then be digitized and recorded. One desirable way to use this data is to accurately determine the current or temperature required to place the VCSEL wavelength at the etalon transmittance peak. The data can simply be examined for the maximum amplitude value or, more accurately, a curve fitting algorithm can be used to find the peak of the best fit curve. Using this simple method with the etalon described above, along with a data collection system that recorded the response at current increments producing VCSEL wavenumber changes of about 0.005 cm−1 per increment, the wavenumber at the etalon peak could be determined with a repeatability of better than 0.001 cm−1. In a wavelength maintenance scheme the VCSEL current or temperature required to place it at the etalon peak can be periodically determined in this way and set to that point for calibrated operation. One advantage of this scheme over others to be described is that the wavelength control point is the etalon passband peak and is independent of other factors such as etalon bandwidth, passband symmetry, or VCSEL intensity.

Amplitude vs. wavelength data can be collected in a number of ways. In a system using good temperature and current stability the VCSEL wavelength needs only to be measured infrequently. In this case it is often possible to periodically operate the instrument in a special calibration mode in which the instrument is not available for other purposes during the period in which the VCSEL wavelength is being changed to locate the etalon passband peak. In other cases it may be desirable to continuously update the VCSEL wavelength to lock it to the etalon. One way of accomplishing this is to make measurements during the OPD scanner turn around time. In interferometers using a reciprocating element for OPD scanning there is often a turn around time during which interferogram data is not taken. In a scheme such as that illustrated in FIG. 21 this turn around time can be used, for example, to change the current to a new test value, make an amplitude measurement, and return to the operating current in time to begin the next scan. Depending on the response time of the measuring electronics and the available turn around time, one or more current values can be recorded during each turn around period. In this way the desired range of response vs. current values can be continuously updated over a small number of scans and used to adjust the operating current as needed to maintain a constant wavelength.

The wavelength of the VCSEL can also be set to operate at a point other than at the etalon passband peak. For example, the wavelength could be set to a position on the steep slope of the passband and a voltage comparator used to maintain the wavelength by comparing the VCSEL signal with a preset reference voltage. This results in a simple control algorithm that could be implemented in either a digital or analog signal processor. To maintain accuracy in this kind of scheme it is desirable that the reference voltage be determined from a photodetector that looks at the VCSEL amplitude before going through the etalon. Otherwise the wavelength set point will change with the signal amplitude and cause unwanted wavelength changes as the device ages and changes output amplitude. The scheme is also subject to other amplitude-changing errors such as amplifier offsets and gain drift. It is also sensitive to any changes in the etalon passband width. As a consequence, this scheme should not be considered as accurate as those that depend only on the shape of a small region around the etalon peak.

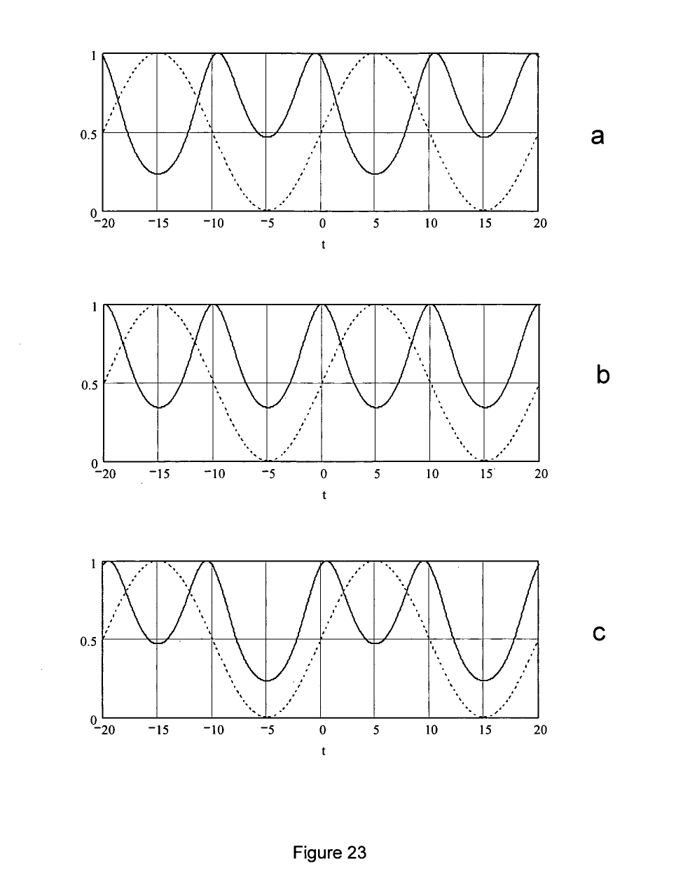

Another way of generating control data is to continuously modulate the VCSEL current at a frequency much higher than that generated by the OPD scanner and then process the signal in two separate channels. The peak-to-peak amplitude of the high frequency modulation signal should preferably be such that it changes the VCSEL wavelength by less than the half amplitude bandwidth of the etalon. Any of the previously discussed optical arrangements can be used with this scheme but it is most easily illustrated using the scheme of FIG. 21. The channel through the interferometer, used for the normal OPD determination, includes a low pass filter to eliminate the high frequency modulation in that path. If the modulation frequency is sufficiently high the low pass filter built into many commercial analog to digital converters will effectively remove it. The other channel collects light from a beam splitter before it enters the interferometer and detects only the high frequency modulation. In this channel the relationship between drive current and output response can be examined to determine the relationship between current and etalon passband position. FIG. 23 shows a few cycles of the waveform generated in the photodetector (solid line), relative to the modulating waveform (dotted line) in three cases where the VCSEL wavelength is above, equal to and below the etalon passband peak wavelength. Although a sinusoidal modulation is shown in the illustration other waveforms, such as a square wave, can be used.

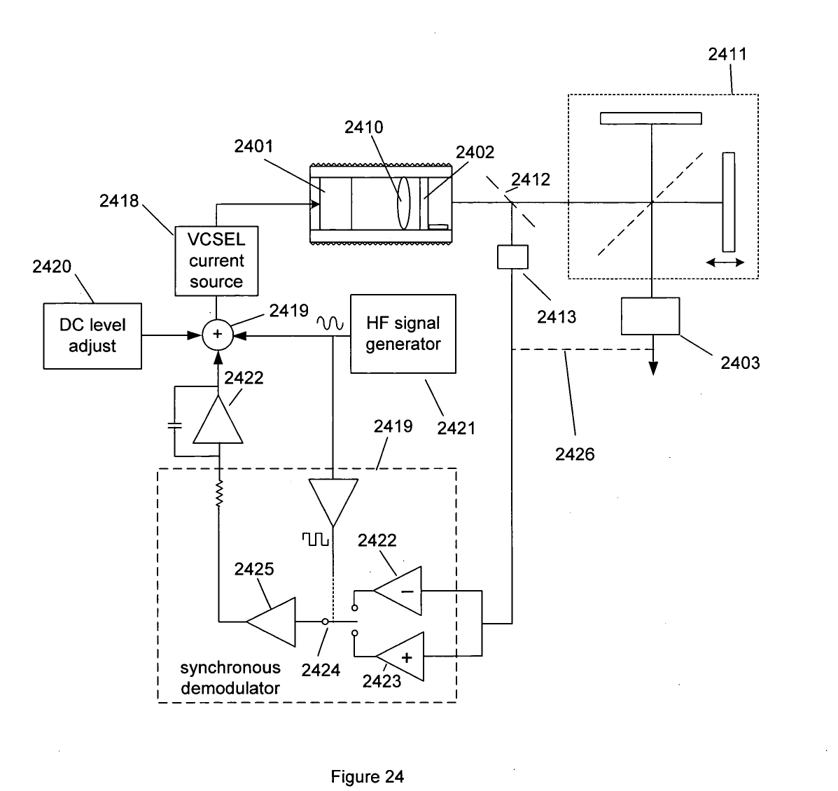

FIG. 24 shows an example method for using this signal in an analog wavelength locking scheme. In this scheme the VCSEL drive current source 2418 is controlled by the sum 2419 of three signals. One of these is a DC level adjust 2420 which is used to set the VCSEL wavelength near a selected etalon passband peak. The second signal is from a high frequency signal generator 2421 and the third is from the output of an error integrator 2422. This current then drives VCSEL 2401, modulating its wavelength over a small range. The VCSEL's output passes through a collimator 2410 and an etalon 2402. A beam splitter 2412 and photo detector 2413 samples a portion of the VCSEL output light before it enters the interferometer 2411. A signal from the detector 2413 can be demodulated using a circuit 2419 synchronized with the high frequency modulating signal. A commercially available integrated circuit, such as that provided by Analog Devices type AD630, can be configured to perform this function. In this circuit the signal is amplified by inverting 2422 and non-inverting 2423 amplifiers. A switch 2424, synchronized with zero crossings of the modulating signal then switches the input of a buffer amplifier 2425 between the inverted and non-inverted signals. The output of this buffer then drives an integrator 2422 which effectively subtracts the average signal during the positive half of the modulating cycle from the average signal during the negative half, generating an error signal proportional to the distance of the average VCSEL wavelength from the etalon passband peak. Demodulation can also be accomplished by a four quadrant multiplier. This error signal is then added 2419 to provide negative feedback to correct the DC current of the VCSEL to maintain the VCSEL wavelength very near the etalon peak. One way of looking at this control scheme is that it compares etalon transmittance values from points equidistant on opposite sides of a line of symmetry. When this line of symmetry coincides with the etalon passband peak the values from opposite sides are equal and the signal produced by the error integrator goes to zero. Strictly speaking, with equal amplification in both halves of the demodulator this point will be slightly off the etalon peak because the AC signal produced by the signal generator 2421 produces both amplitude modulation and wavelength modulation of the VCSEL. To compensate for the VCSEL amplitude modulation a gain adjustment in either the inverting or non-inverting amplifier of the demodulator can be included to allow the error signal to be zeroed at the true etalon peak. In practice, with a small modulation signal the error is small and can often be ignored. The offset will also be nearly constant, with only slight dependency on changes in system parameters such as the slope of the VCSEL current to light intensity function. The accuracy of this scheme is also affected by gain changes and biases in the analog components but can be minimized through careful design and component selection. Such errors can be avoided by implementing the equivalent process in a digital signal processor wherein the modulated signal is digitized and values obtained during the positive and negative halves of the modulation waveform are compared. In general, this high frequency modulation scheme, should produce more accurate wavelength control than approaches based on maintaining the wavelength on the slope of the etalon, since, like the first scheme presented, it locates a point of symmetry near the etalon peak, independent of the etalon bandwidth.

As previously stated, this wavelength control scheme can be used with a variety of optical configurations, including those which use a single VCSEL signal detector at the output of the interferometer. For example, an alternative connection 2426 to the synchronous demodulator is also possible. Here the OPD sensing detector 2403 at the interferometer output is directed into the demodulator instead of the output of the auxiliary detector 2413, eliminating the need for the auxiliary beam splitter 2412 and detector 2413. In this case the time constant of integrator 2422 is increased to eliminate the relatively low frequency modulation of the VCSEL control current that might result from the interferometer OPD scanner movement. Choice of an optical configuration and control system parameters are dependent on a number of system related issues. For example, in a system in which the scanning motion of the interferometer OPD scanner is stopped during idle periods the intensity of the signal at the output of detector 2403 may become indeterminate and unreliable for maintaining the wavelength feedback control. There could then be a period after startup during which the wavelength could be in error, depending on the control loop response time. In some applications this might be an undesirable factor pointing to use of the output of detector 2413 as the preferred arrangement.

Those skilled in the art will recognize that the present invention may be manifested in a variety of forms other than the specific embodiments described and contemplated herein. Accordingly, departures in form and detail may be made without departing from the scope and spirit of the present invention as described in the appended claims.

1. A subassembly for use in optical spectroscopy comprising:
a) an interferometer including optical components for receiving light and passing the light along a defined light path, the optical components including a beamsplitter separating the light into two portions and means for introducing a path length difference between the portions;
b) a vertical cavity surface emitting laser, including electronics to drive the vertical cavity surface emitting laser to project a beam therefrom, operatively mounted with the interferometer with a portion of the beam generally following the defined light path and a portion of the beam interacting with a defined response element and then to a detector, the vertical cavity surface emitting laser including an operating parameter control system for controlling an operating parameter of the vertical cavity surface emitting laser responsive to a signal from the detector.

2. A subassembly as in claim 1, wherein the defined response element comprises an etalon.

3. A subassembly as in claim 1, wherein the operating parameter control system controls the drive current to the vertical cavity surface emitting laser.

4. A subassembly as in claim 1, wherein the operating parameter control system controls the temperature of the vertical cavity surface emitting laser.

5. A subassembly as in claim 1, wherein the operating parameter control system controls the angle of propagation of the light emitted from the VCSEL.

6. A subassembly as in claim 1, wherein the operating parameter control system controls an operating parameter of the vertical cavity surface emitting laser to establish a selected level of energy detected by the detector.

7. A subassembly as in claim 1, wherein the operating parameter control system maintains the operating parameter at a first substantially stable level during an operating period, and establishes a second level that establishes a selected level of energy detected by the detector during a control period.

8. A subassembly as in claim 1, wherein the defined response element has a maximum transmittance of energy having a desired wavelength, and wherein the operating parameter control system adjusts the operating parameter such that the energy detected by the detector is at a maximum and the output wavelength of the vertical cavity surface emitting laser is accordingly substantially at the desired wavelength

9. A subassembly as in claim 1, wherein the defined response element has a minimum reflectance of energy having a desired wavelength, and wherein the operating parameter control system adjusts the operating parameter such that the energy detected by the detector is at a minimum and the output wavelength of the vertical cavity surface emitting laser is accordingly substantially at the desired wavelength.

10. A subassembly as in claim 1, wherein the vertical cavity surface emitting laser supplies a reference laser for the interferometer.

11. An optical spectrometer, comprising:
a) a vertical cavity surface emitting laser subsystem;
b) an interferometer, in optical communication with the vertical cavity surface emitting laser subsystem;
c) an etalon subsystem, mounted in an optical path from the vertical cavity surface emitting laser subsystem to the interferometer;
d) a detector, in optical communication with the interferometer;
e) a wavelength control processor, responsive to a signal from the detector and adapted to control an operating parameter of the vertical cavity surface emitting laser subsystem.

12. An optical spectrometer as in claim 11, wherein:
a) the etalon subsystem comprises a temperature control system adapted to maintain a substantially constant operating temperature of the optical components of the etalon;
b) the vertical cavity surface emitting laser subsystem comprises a temperature control system adapted to maintain a substantially constant operating temperature of the vertical cavity surface emitting laser; and
c) the wavelength control processor comprises a variable current source connected to drive the vertical cavity surface emitting laser subsystem, and wherein the wavelength control processor controls the output of the variable current source.

13. An optical spectrometer, comprising:
a) a vertical cavity surface emitting laser subsystem, adapted to provide collimated output light;
b) an interferometer in optical communication with the vertical cavity surface emitting laser subsystem;
c) a detector in optical communication with the interferometer;
d) an etalon subsystem mounted in an optical path from the interferometer to the detector;
e) a wavelength control processor, responsive to a signal from the detector and adapted to control an operating parameter of the vertical cavity surface emitting laser subsystem.

14. An optical spectrometer according to claim 13, wherein:
a) the etalon subsystem comprises a temperature control system adapted to maintain a substantially constant operating temperature of the optical components of the etalon;
b) the vertical cavity surface emitting laser subsystem comprises a temperature control system adapted to maintain a substantially constant operating temperature of the vertical cavity surface emitting laser; and
c) the wavelength control processor comprises a variable current source connected to drive the vertical cavity surface emitting laser subsystem, and wherein the wavelength control processor controls the output of the variable current source.

15. A subsystem generating output light for use with an optical spectrometer, comprising:
a) a vertical cavity surface emitting laser subsystem, adapted to provide collimated light;
b) an auxiliary beam splitter in optical communication with the vertical cavity surface emitting laser, defining an output optical path and a feedback optical path;
c) a detector receiving light along the feedback optical path;
d) an etalon subsystem mounted in an optical path from the vertical cavity surface emitting laser subsystem to the detector;
e) a wavelength control processor responsive to a signal from the detector and adapted to control an operating parameter of the vertical cavity surface emitting laser subsystem.

16. A subsystem according to claim 15, wherein:
a) the etalon subsystem comprises a temperature control system adapted to maintain a substantially constant operating temperature of the optical components of the etalon;
b) the vertical cavity surface emitting laser subsystem comprises a temperature control system adapted to maintain a substantially constant operating temperature of the vertical cavity surface emitting laser; and
c) the wavelength control processor comprises a variable current source connected to drive the vertical cavity surface emitting laser subsystem, and wherein the wavelength control processor controls the output of the variable current source.

17. An optical spectrometer, comprising:
a) a vertical cavity surface emitting laser subsystem;
b) an etalon having a transmission axis therethrough, in optical communication with the vertical cavity surface emitting laser subsystem and with the transmission axis oriented non-parallel with light from the vertical cavity surface emitting laser subsystem;
c) a beam splitter in optical communication with the etalon, directing light from the etalon along first and second optical paths;
d) a first detector in optical communication with the beam splitter along the first optical path;
e) an interferometer in optical communication with the beam splitter along the second optical path, wherein light along the second optical path encounters the interferometer at an input port thereof, and wherein light exiting the interferometer via an exit port thereof does not encounter the beam splitter;
f) a second detector in optical communication with the exit port of the interferometer;
g) a wavelength control system, responsive to a signal from the first detector and adapted to control an operating parameter of the vertical cavity surface emitting laser subsystem.

18. An optical spectrometer as in claim 17, wherein:
a) the vertical cavity surface emitting laser subsystem comprises a lasing portion;
b) the vertical cavity surface emitting laser subsystem comprises an aperture configured so that light returning to the vertical cavity surface emitting laser subsystem from the etalon is substantially prevented from reaching the lasing portion of the vertical cavity surface emitting laser subsystem by the aperture;
c) the vertical cavity surface emitting laser subsystem comprises a temperature control system, adapted to maintain a substantially constant operating temperature of the lasing portion;
d) the beam splitter comprises a substrate with a portion coated with a beam-splitting coating disposed in the path of light traveling from the etalon to the beam splitter;
e) a portion of the substrate is coated with a reflective coating and is disposed in the path of light from the exit port of the interferometer such that such light is directed to the second detector.

19. An optical spectrometer, comprising:
a) a vertical cavity surface emitting laser subsystem;
b) an interferometer in optical communication with the vertical cavity surface emitting laser subsystem;
c) an auxiliary beam splitter in an optical path from the vertical cavity surface emitting laser to the interferometer, defining a first optical path to the interferometer and a second optical path;
d) an auxiliary detector in the second optical path;
e) an etalon subsystem in an optical path from the vertical cavity surface emitting laser subsystem to the auxiliary detector;
f) a wavelength control system, responsive to a signal from the auxiliary detector, adapted to modulate a drive current to the vertical cavity surface emitting laser subsystem, and adapted to control the drive current such that the optical energy passed through the etalon is substantially maximized.

20. An optical spectrometer as in claim 19, wherein the wavelength control system is adapted to modulate the drive current to the VCSEL subsystem according to a modulation characteristic, and wherein the wavelength control system is adapted to demodulate the signal from the detector according to the modulation characteristic.

21. An optical spectrometer, comprising:
a) a vertical cavity surface emitting laser subsystem;
b) an interferometer in optical communication with the vertical cavity surface emitting laser subsystem;
c) a detector in optical communication with an output port of the interferometer;
d) an etalon subsystem in an optical path from the vertical cavity surface emitting laser subsystem to the detector;
e) a wavelength control system, responsive to a signal from the detector, adapted to modulate a drive current to the vertical cavity surface emitting laser subsystem, and adapted to control the drive current such that the optical energy passed through the etalon is substantially maximized.

22. An optical spectrometer as in claim 21, wherein the wavelength control system is adapted to modulate the drive current to the VCSEL subsystem according to a modulation characteristic, and wherein the wavelength control system is adapted to demodulate the signal from the detector according to the modulation characteristic.

23. A subassembly as in claim 1, wherein the defined response element comprises an etalon chosen from the group consisting of:
a) an optically transmissive substrate having two substantially parallel opposing surfaces, where each surface is partially reflecting;
b) first and second plates, spaced apart and substantially parallel, where the first and second plates are substantially parallel;
c) first and second plates, spaced apart and substantially parallel, where the first and second plates are substantially parallel and wherein the space between the plates is at a substantially constant pressure;
d) first and second plates, spaced apart and substantially parallel, where the first and second plates are substantially parallel and wherein the space between the plates is filled with a material of substantially constant composition;
e) an optically transmissive substrate having opposing partially reflecting surfaces, where the optical path length through the etalon encountered by light from the vertical cavity surface emitting laser is substantially the same for all paths through the etalon from the vertical cavity surface emitting laser;
f) an etalon having a free spectral range smaller than the total range of vertical cavity surface emitting laser output wavelengths reachable by control of the operating parameter.

24. A method of providing a source of energy having a stable wavelength for optical spectroscopy, comprising:
a) providing a VCSEL;
b) providing a detector in optical communication with the VCSEL;
c) providing a defined response element in a path from the VCSEL to the detector, where the defined response element has a minimum absorbance at a desired wavelength;
d) adjusting the operating environment of the VCSEL to change the wavelength of the VCSEL output over a range including the desired wavelength,
e) monitoring the energy received by the detector, and
f) maintaining the operating environment of the VCSEL where the monitored energy is at a maximum.

25. A method as in claim 24, wherein providing an etalon comprises providing an etalon chosen from the group consisting of:
a) an optically transmissive substrate having two substantially parallel opposing surfaces, where each surface is partially reflecting;
b) first and second plates, spaced apart and substantially parallel, where the first and second plates are substantially parallel;
c) first and second plates, spaced apart and substantially parallel, where the first and second plates are substantially parallel and wherein the space between the plates is at a substantially constant pressure;
d) first and second plates, spaced apart and substantially parallel, where the first and second plates are substantially parallel and wherein the space between the plates is filled with a material of substantially constant composition;
e) an optically transmissive substrate having opposing partially reflecting surfaces, where the optical path length through the etalon encountered by light from the vertical cavity surface emitting laser is substantially the same for all paths through the etalon from the vertical cavity surface emitting laser;
f) an etalon having a free spectral range smaller than the total range of vertical cavity surface emitting laser output wavelengths reachable by control of the operating parameter.

26. A method as in claim 24, wherein adjusting the operating environment of the VCSEL comprises adjusting the operating temperature of the VCSEL, adjusting the drive current supplied to the VCSEL, or a combination thereof.

27. A light source, comprising:
a) a multimode VCSEL, emitting light at a plurality of VCSEL wavelengths over a range of wavelengths;
b) an etalon, in optical communication with the VCSEL, providing output light from transmission of light in a plurality of etalon passbands, where at least one of the VCSEL wavelengths is within at least one of the etalon passbands.

28. A light source as in claim 27, wherein the VCSEL comprises means for adjusting the operation of the VCSEL such that the VCSEL wavelengths change.

29. A light source as in claim 28, wherein adjusting the operation of the VCSEL comprises adjusting the operating temperature of the VCSEL, the drive current supplied to the VCSEL, or a combination thereof.

30. A light source as in claim 27, wherein the etalon comprises means for adjusting the operation of the etalon such that the etalon passbands change.

31. A light source as in claim 30, wherein adjusting the operation of the etalon comprises adjusting the operating temperature of the etalon, the angle of the etalon to light from the VCSEL, the pressure of a medium between reflective surfaces of the etalon, or a combination thereof.

32. A light source as in claim 27, wherein the free spectral range of the etalon is larger than the range of VCSEL wavelengths.
